(19) United States
(12) Patent Application Publication
(10) Pub. No.: US 2024/0304350 A1
(43) Pub. Date: Sep. 12, 2024

(54) METHODS AND SYSTEMS FOR NUCLEAR REACTOR DESIGN USING FUEL-CLADDING THERMO-MECHANICS ANALYSIS

(71) Applicant: GEORGIA TECH RESEARCH CORPORATION, Atlanta, GA (US)

(72) Inventors: Anna S. ERICKSON, Atlanta, GA (US); Nicholas J. FASSINO, Atlanta, GA (US)

(21) Appl. No.: 18/572,666

(22) PCT Filed: Jun. 24, 2022
(86) PCT No.: PCT/US2022/034886

§ 371 Date: Dec. 20, 2023

Related U.S. Application Data
(60) Provisional application No. 63/215,021, filed on Jun. 25, 2021.

(51) Int. Cl. G21D 3/00

(52) U.S. Cl. CPC G21D 3/002

(57) ABSTRACT

Described herein are methods for analyzing an operating envelope of a nuclear reactor. An example method includes obtaining operating envelope parameters associated with a first reactor core by performing a plurality of thermo-hydraulic and thermo-mechanical calculations for the first reactor core, where the first reactor core includes a first fuel-cladding material and has a first fuel pin geometry; obtaining operating envelope parameters associated with a second reactor core by performing a plurality of thermo-hydraulic and thermo-mechanical calculations for the second reactor core, where the second reactor core includes a second fuel-cladding material and has a second fuel pin geometry; and assessing an expandable operating envelope by comparing the respective operating envelope parameters associated with the first reactor core and the second reactor core, where the first and second fuel-cladding materials are different materials. The example method can include iteratively performing the steps described herein.

### CROSS-REFERENCE TO RELATED APPLICATIONS

This application claims the benefit of U.S. provisional patent application No. 63/215,021, filed on Jun. 25, 2021, and titled “METHOD AND SYSTEM FOR NUCLEAR REACTOR OPERATING ENVELOPE EXPANSION USING FUEL-CLAD THERMO-MECHANICS ANALYSIS,” the disclosure of which is expressly incorporated herein by reference in its entirety.

### STATEMENT REGARDING FEDERALLY FUNDED RESEARCH

This invention was made with government support under Grant no. DE-AR00001066 awarded by the Advanced Research Projects Agency-Energy (ARPA-E). The government has certain rights in the invention.

### BACKGROUND

A major impediment to the operation of solid-fuel reactor concepts is the performance of their fuel cladding materials [1]. In light-water reactors, accident conditions can result in prohibitive cladding oxidation. In several advanced reactor systems, high-temperature corrosive coolants, for example lead and lead-bismuth, can lead to damage of traditional cladding materials-relying on a protective oxide layer-unless coolant velocity and temperatures are limited [2, 3, 4].

While a computational tools and subcodes such as FALCON [5] and MATPRO [6] have been developed to accurately analyze the performance of nuclear fuels and their effects on the reactor operating envelope, none perform the function of comparing sets of results and identifying potential means of operating envelope expansion through fuel pin geometry manipulation. For example, the Fuel Rod Integral Performance Analysis Code (FRIPAC), developed by China Nuclear Power Technology Research Institute Co. Ltd, utilizes a suite of models to predict pressurized water reactor (PWR) fuel pin behaviors during steady-state and power-ramp conditions [7]. FRAPCON, a computer code for the calculation of steady-state thermal-mechanical behavior of oxide fuel rods for high burnup, developed by Pacific Northwest National Laboratory [8], is designed to perform steady-state fuel rod calculations and generate inputs for its associated transient analyses code FRAPTRAN. BISON, a finite element-based nuclear fuel performance code developed with the MOOSE framework by Idaho National Laboratory, can solve problems pertaining to light water reactor (LWR) fuel rods, tri-structural isotropic particle (TRISO) fuels, metallic fuels, and plate fuels [9]. Additionally, these codes were designed for LWR analysis and have not been validated for reactor designs with exotic coolants.

Therefore, what is required are systems and methods directed to these and other considerations.

### SUMMARY

Systems and methods for designing nuclear reactors are described herein. The systems and methods described herein facilitate nuclear reactor operating envelope expansion using fuel-clad thermo-mechanics analysis.

An example computer implemented method for analyzing an operating envelope of a nuclear reactor is described herein. The computer implemented method includes (a) receiving a plurality of reactor input parameters for a reactor core including a first fuel-cladding material, the reactor input parameters including geometric parameters, coolant parameters, fuel parameters, and neutronic parameters; (b) for each of a plurality of depletion steps in a fuel cycle, performing a plurality of thermo-hydraulic and thermo-mechanical calculations for the reactor core including the first fuel-cladding material based on the reactor input parameters; (c) repeating step (b) for each of a plurality of coolant inlet temperatures to obtain a plurality of operating envelope parameters associated with the reactor core including the first fuel-cladding material; (d) modifying a fuel pin geometry of the reactor core including the first fuel-cladding material; (e) for each of the plurality of depletion steps in the fuel cycle, performing the plurality of thermo-hydraulic and thermo-mechanical calculations for the reactor core including the first fuel-cladding material based on the reactor input parameters and the modified fuel pin geometry; (f) repeating step (e) for each of the plurality of coolant inlet temperatures to obtain a plurality of operating envelope parameters associated with the reactor core including the first fuel-cladding material and having the modified fuel pin geometry; (g) for each of the plurality of depletion steps in the fuel cycle, performing the plurality of thermo-hydraulic and thermo-mechanical calculations for the reactor core including a second fuel-cladding material based on the reactor input parameters, the modified fuel pin geometry, and a change in fuel-cladding material; (h) repeating step (g) for each of the plurality of coolant inlet temperatures to obtain a plurality of reactor operating envelope parameters associated with the reactor core including the second fuel-cladding material and having the modified fuel pin geometry; and (i) determining whether a reactor operating envelope of the reactor core is expanded as a result of the change in fuel-cladding material by comparing the respective operating envelope parameters associated with the reactor core including the first fuel-cladding material and the reactor core including the second fuel-cladding material and having the modified fuel pin geometry.

Alternatively or additionally, the plurality of thermo-hydraulic and thermo-mechanical calculations include pin-specific calculations of one or more of coolant, cladding, and fuel temperature profiles; fuel deformations; cladding deformations; or pressures at the coolant-cladding, fuel-cladding, and gas-clad interfaces.

Alternatively or additionally, the fuel pin geometry includes one or more of a fuel-cladding gap width or a cladding thickness.

Alternatively or additionally, each of steps (b), (e), and (g) are repeated until the fuel cycle is complete. Optionally, each of steps (c), (f), and (h) are repeated at incrementally increasing coolant inlet temperatures. Optionally, steps (e)-(f) are repeated until an effective stress on the first fuel-cladding material is greater than a maximum allowable stress on the first fuel-cladding material at a final depletion step of the fuel cycle and a final coolant inlet temperature.

Alternatively or additionally, the operating envelope parameters are indexed to an assembly, a fuel pin, an axial zone, a depletion step, and a coolant inlet temperature.

Alternatively or additionally, the operating envelope parameters include one or more of temperature parameters, pressure parameters, fuel deformation parameters, cladding deformation parameters, or mechanics parameters. Optionally, the temperature parameters include one or more of a coolant outlet temperature, a coolant bulk temperature, a cladding inner surface temperature, a cladding outer surface temperature, a fuel surface temperature, a fuel centerline temperature, or a fuel average temperature. Optionally, the pressure parameters include one or more of a fuel-cladding interface pressure, a fuel-gas interface pressure, or a coolant-cladding interface pressure. Optionally, the fuel deformation parameters include one or more of a thermal expansion, a relocation densification, a swelling due to fission products, an elasticity, or a creep. Optionally, the cladding deformation parameters include a thermal expansion. Optionally, the mechanics parameters include one or more of a maximum allowable cladding stress or an effective cladding stress.

Alternatively or additionally, the geometric parameters include one or more of a fuel radius, a cladding thickness, an active core height, a plenum height, a pin pitch, an assembly coolant channel radius or apothem, a number of assemblies, or a number of fuel pins per assembly.

Alternatively or additionally, the coolant parameters include one or more of a mass flow rate, a coolant inlet temperature, a coolant boiling point, or a coolant inlet pressure.

Alternatively or additionally, the fuel parameters include one or more of a theoretical fuel density or a fuel cycle length.

Alternatively or additionally, the neutronic parameters include one or more of an axially discretized pin fission rate, a core nominal power, a fuel and fission product isotropic inventory as a functions of depletion, or a number of depletion steps.

An example system for analyzing an operating envelope of a nuclear reactor is described herein. The system includes a processor; and a memory operably coupled to the processor, the memory having computer-executable instructions stored thereon that, when executed by the processor, cause the processor to: (a) receive a plurality of reactor input parameters for a reactor core including a first fuel-cladding material, the reactor input parameters including geometric parameters, coolant parameters, fuel parameters, and neutronic parameters; (b) for each of a plurality of depletion steps in a fuel cycle, perform a plurality of thermo-hydraulic and thermo-mechanical calculations for the reactor core including the first fuel-cladding material based on the reactor input parameters; (c) repeat step (b) for each of a plurality of coolant inlet temperatures to obtain a plurality of operating envelope parameters associated with the reactor core including the first fuel-cladding material; (d) modify a fuel pin geometry of the reactor core including the first fuel-cladding material; (e) for each of the plurality of depletion steps in the fuel cycle, perform the plurality of thermo-hydraulic and thermo-mechanical calculations for the reactor core including the first fuel-cladding material based on the reactor input parameters and the modified fuel pin geometry; (f) repeat step (e) for each of the plurality of coolant inlet temperatures to obtain a plurality of operating envelope parameters associated with the reactor core including the first fuel-cladding material and having the modified fuel pin geometry; (g) for each of the plurality of depletion steps in the fuel cycle, perform the plurality of thermo-hydraulic and thermo-mechanical calculations for the reactor core including a second fuel-cladding material based on the reactor input parameters, the modified fuel pin geometry, and a change in fuel-cladding material; (h) repeat step (g) for each of the plurality of coolant inlet temperatures to obtain a plurality of reactor operating envelope parameters associated with the reactor core including the second fuel-cladding material and having the modified fuel pin geometry; and (i) determine whether a reactor operating envelope of the reactor core is expanded as a result of the change in fuel-cladding material by comparing the respective operating envelope parameters associated with the reactor core including the first fuel-cladding material and the reactor core including the second fuel-cladding material and having the modified fuel pin geometry.

Another example computer implemented method for analyzing an operating envelope of a nuclear reactor is described herein. The computer implemented method can include obtaining a plurality of operating envelope parameters associated with a first reactor core by performing a plurality of thermo-hydraulic and thermo-mechanical calculations for the first reactor core, where the first reactor core includes a first fuel-cladding material and has a first fuel pin geometry; obtaining a plurality of operating envelope parameters associated with a second reactor core by performing a plurality of thermo-hydraulic and thermo-mechanical calculations for the second reactor core, where the second reactor core includes a second fuel-cladding material and has a second fuel pin geometry; and assessing an expandable operating envelope by comparing the respective operating envelope parameters associated with the first reactor core and the second reactor core, where the first and second fuel-cladding materials are different materials.

Additionally, the first and second fuel pin geometries are optionally the same fuel pin geometry. Alternatively, the first and second fuel pin geometries are optionally different fuel pin geometries.

Alternatively or additionally, the plurality of thermo-hydraulic and thermo-mechanical calculations include pin-specific calculations of one or more of coolant, cladding, and fuel temperature profiles; fuel deformations; cladding deformations; or pressures at the coolant-cladding, fuel-cladding, and gas-clad interfaces.

Alternatively or additionally, the plurality of thermo-hydraulic and thermo-mechanical calculations are iteratively performed for each of a plurality of depletion steps in a fuel cycle. Thereafter, optionally, the plurality of thermo-hydraulic and thermo-mechanical calculations are iteratively performed for each of a plurality of coolant inlet temperatures.

Alternatively or additionally, the plurality of thermo-hydraulic and thermo-mechanical calculations are performed based on a plurality of reactor input parameters. Optionally, the reactor input parameters include geometric parameters, coolant parameters, fuel parameters, and neutronic parameters.

Alternatively or additionally the operating envelope parameters are indexed to an assembly, a fuel pin, an axial zone, a depletion step, and a coolant inlet temperature.

Alternatively or additionally, the operating envelope parameters include one or more of temperature parameters, pressure parameters, fuel deformation parameters, cladding deformation parameters, or mechanics parameters.

Alternatively or additionally, the method can be implemented by a system including a processor; and a memory operably coupled to the processor, the memory having computer-executable instructions stored thereon that, when executed by the processor, cause the processor to perform any one of the method steps.

Alternatively or additionally, the method can be implemented as a computer-readable recording medium having computer-executable instructions stored thereon that, when executed by a processor, cause the processor to perform any or all of the method steps.

In another implementation, an analytical tool is disclosed. The tool is implemented in MATLAB (referred to herein as “REX”) that can take core geometries and axially discretized detector and depletion output from the Serpent neutron transport code and performs full-core, pin-specific thermal-hydraulic and thermo-mechanical calculations. The analytical tool (REX) can identify the operating envelopes of advanced, solid-fuel nuclear reactors on the basis of their fuel-cladding, fuel-gas, and coolant-cladding interfacial thermo-mechanics.

In some embodiments, the analytical tool can iteratively push operating condition of coolant inlet temperatures and modify fuel-pin geometries to induce mechanical failure in their original cladding materials at the fullest extent of their fuel cycle lengths and permissible coolant inlet temperatures. The analytical tool can then attempt to expand their operating envelopes by determining/predicting the mechanical responses of alternative cladding materials under the same geometric conditions. The result of the REX calculation sequence, in some embodiments, is a set of five dimensional (5-D) variables describing the temperatures, pressures, geometries, and mechanics of the core as functions of assembly, fuel pin, axial zone, depletion step, and coolant inlet temperature for each candidate cladding material with the limiting fuel pin geometry for the original material.

In an example, the analytical tool is used to evaluate the thermo-mechanical operating envelope of a pin-type fluoride salt-cooled high temperature reactor (FHR) with silicon carbide (SiC) fuel cladding. The analytical tool can assess the envelope of this reactor can be expanded however, due to inferior temperature tolerances of the alternative cladding materials (Ni-201, HAYNES alloy 230, INCOLOY 800H, and Inconel 718). The output of the sample problem is a set of .mat files (one for each tested material) whose contents are interpreted with surface plots of the effective and maximum allowable stresses as functions of depletion step and coolant inlet temperature

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates a framework for expanding the operating envelope of a reactor, according to an example implementation.

FIG. 1B is a flowchart that illustrates a method of expanding the operating envelope of a reactor, according to an example implementation.

FIG. 2A illustrates non-limiting examples of inputs to the methods illustrated in FIG. 1A and FIG. 1B.

FIG. 2B illustrates non-limiting examples of outputs that can be generated using the methods illustrated in FIG. 1A and FIG. 1B.

FIG. 3A illustrates a solid cylindrical fuel element including fuel, a gap, clad, and coolant, according to an example implementation of the present disclosure.

FIG. 3B illustrates a visualization of void-closure treatment of radial fuel swelling and fuel-clad gap closure in discrete axial zones, including fuel, gap, and clad.

FIG. 4 illustrates example core parameters used in an example implementation of the present disclosure.

FIG. 5 illustrates example run parameters used in a Serpent simulation according to an example implementation of the present disclosure.

FIG. 6 illustrates initial and adjusted parameters for the limiting fuel pin of an example implementation of the present disclosure.

FIG. 7A and FIG. 7B illustrate geometry plots produced by Serpent. FIG. 7A illustrates an example core, and FIG. 7B illustrates a fuel assembly.

FIG. 8 illustrates non-limiting example materials and coolants that can be used in implementations of the present disclosure.

FIGS. 9A and 9B illustrate plots showing the output of a non-limiting example implementation converging on an ideal geometry.

FIG. 10A illustrates SiC effective stress and fracture strength with an example limiting fin geometry.

FIG. 10B illustrates an attempt to example fluoride salt-cooled high-temperature reactor (FHR) operating envelope with Inconel 718, in the plot shown the effective stress exceeds yield strength after yield strength drops to zero due to temperature effects.

FIG. 11 illustrates an example computing device.

FIG. 12A illustrates example parameters for a fluoride salt-cooled high-temperature reactor (FHR), according to an implementation of the present disclosure.

FIG. 12B illustrates example parameters for a lead cooled fast reactor, according to an example implementation of the present disclosure.

FIG. 12C illustrates example parameters for a sodium cooled reactor, according to an example implementation of the present disclosure.

FIG. 13 illustrates a table of non-limiting example gap width and clad thickness pairs, according to an example implementation of the present disclosure.

FIG. 14A illustrates temperature profiles simulated with varying CRL widths, according to an example implementation of the present disclosure.

FIG. 14B illustrates radial interference and interfacial pressures for press fits that can be analyzed using example implementations of the present disclosure.

FIG. 15A illustrates excess hastelloy N stress for different gap widths and clad thicknesses according to an example implementation of the present disclosure.

FIG. 15B illustrates a simulation of excess stress in Inc800H/Ni201 MMLC, according to an example implementation of the present disclosure.

FIG. 15C illustrates excess stress in 230/Ni201 MMLC, according to an example implementation of the present disclosure.

FIG. 15D illustrates example parameters of a small pin-type FHR that can be simulated according to implementations of the present disclosure.

FIG. 16A illustrates a plot of gap width, cladding thickness, and excess stress output by an example implementation of the present disclosure.

FIG. 16B illustrates a plot of tests performed at different gap widths, according to an example implementation of the present disclosure.

FIG. 16C illustrates a plot of excess stress over time for T91/Fe12Cr2Si.

FIG. 16D illustrates a plot of excess stress over time for HT9/Fe12Cr2Si, according to an example implementation of the present disclosure.

FIG. 16E illustrates example parameters of a Large FCR LFR reactor that can be simulated according to implementations of the present disclosure.

FIG. 17A illustrates a plot of gap width, HT9 thickness and excess stress output by an example implementation of the present disclosure.

FIG. 17B illustrates a plot of clad thickness vs. gap width, according to an example implementation of the present disclosure.

FIG. 17C illustrates a plot of excess stress of T91 over time, according to an example implementation of the present disclosure.

FIG. 17D illustrates a plot of excess stress in HT9/Fe12Cr2Si, according to an example implementation of the present disclosure.

FIG. 17E illustrates example parameters of a small SFR reactor that can be simulated according to implementations of the present disclosure.

FIG. 18 illustrates a user interface for inputting simulation parameters that can be used in implementations of the present disclosure.

FIG. 19 illustrates another user interface for inputting simulation parameters that can be used in implementations of the present disclosure.

FIG. 20 illustrates an example user interface for inputting fuel pin positions in an assembly lattice according to implementations of the present disclosure.

FIG. 21 illustrates another example user interface for inputting fuel pin positions in an assembly lattice according to implementations of the present disclosure.

FIG. 22A illustrates an interface showing data being processed from Serpent.

FIG. 22B illustrates an interface showing an example simulation quantifying thermal hydraulics and thermo-mechanics for the full core and identifying the fuel pin with the largest degree of radial deformation.

FIG. 23A illustrates an interface showing a step of manipulating fuel pin geometry to force failure of base clad material (SiC) at the fullest extent of the operating envelope.

FIG. 23B illustrates an interface showing testing the response of alternative materials with fuel pin geometry that limits the operation of the original material.

FIGS. 24A-24D each illustrate the stresses in alternative materials, according to an example implementation of the present disclosure. FIG. 24A illustrates the stresses in Ni201, FIG. 24B illustrates the stresses in Iconel718, FIG. 24C illustrates the stresses in Alloy 230 and FIG. 24D illustrates the stresses in Incoloy 800H.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Implementations of the present disclosure are directed to designing reactors including alternative cladding materials. The implementation of alternative cladding materials can avoid issues related to cladding oxidation, relax coolant velocity constraints, and permit the coolant to deliver additional heat to the power conversion system, thereby expanding the operating envelopes of these reactor designs. The operating envelope of a nuclear reactor can be described as the set of neutronic, thermal-hydraulic, and thermo-mechanical conditions tolerable by reactor materials in the active region of the core.

Specifically, implementations of the present disclosure can natively and dynamically iterate on fuel pin geometries for thermo-mechanical operating envelope identification and expansion.

The example method and system described herein (as embodied computer-readable instructions and system thereof referred to herein as REX) uses several input parameters to perform a series of pin-specific thermal-hydraulic and thermo-mechanical calculations. REX, implementing an analysis for reactor operation envelope and design, can automatically identify and expand the operating envelopes of advanced solid-fuel nuclear reactor cores based on their fuel-clad, fuel-gas, and coolant-clad thermo-mechanics.

With reactor geometry, coolant inlet temperature, and axially discretized detector and depletion results from Serpent as its inputs, in some embodiment, REX and the underlying analysis can perform full-core, pin-specific thermal-hydraulic and thermo-mechanical calculations to determine cladding mechanical stresses as functions of fuel depletion and coolant inlet temperature. It can push the reactor operating envelope by increasing coolant inlet temperature until the coolant boiling point or cladding temperature limit is reached. It then modifies fuel pin geometries to induce mechanical failure of the original cladding material at the full extent of the fuel cycle and maximum permissible coolant inlet temperature. REX can then replace the original cladding with candidate alternative cladding materials specified by the user and evaluates their capability to expand the reactor operating envelope by testing their performance with the limiting fuel pin geometry.

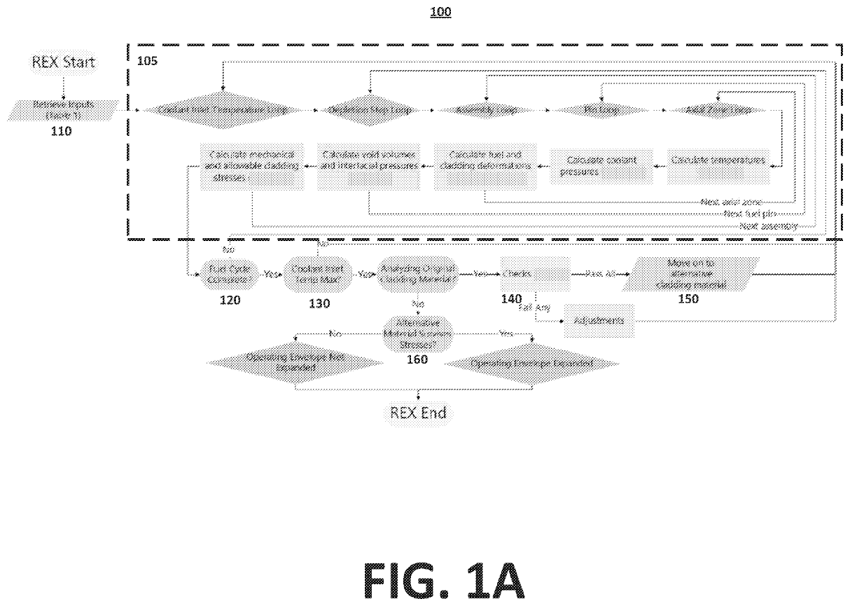

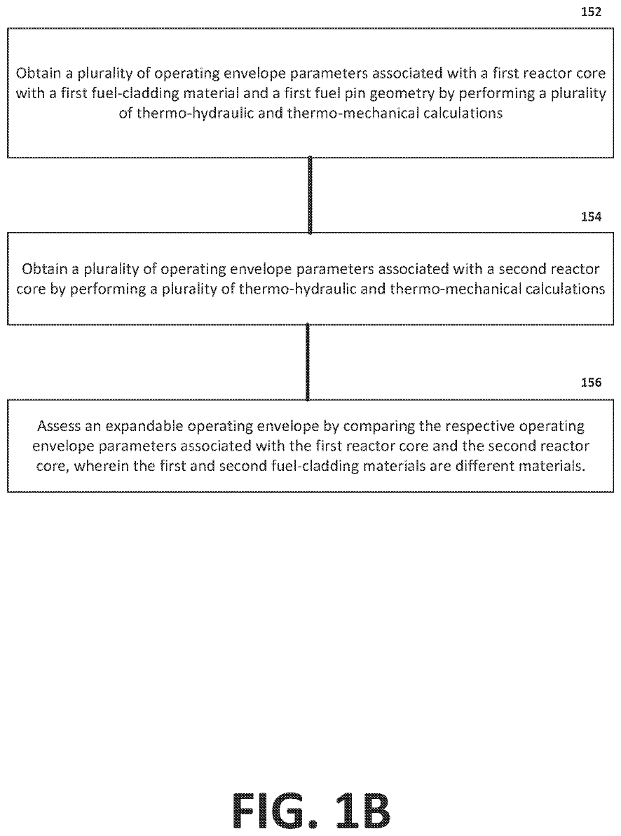

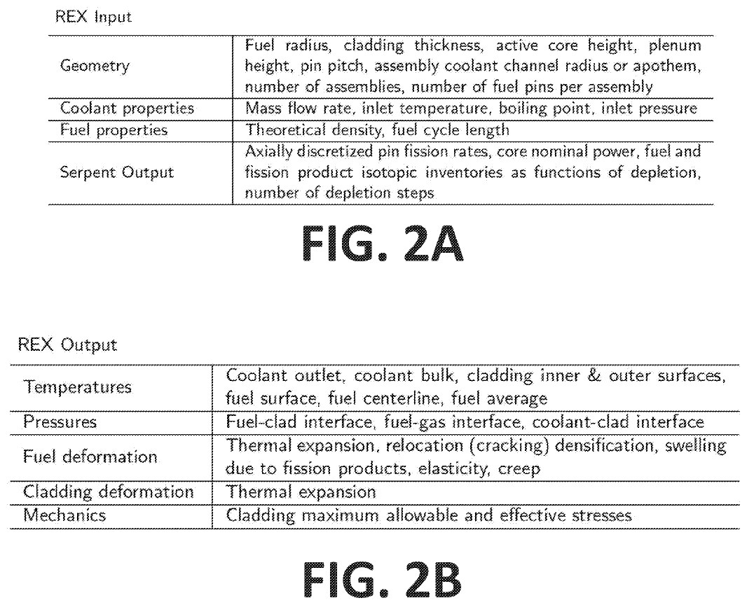

With reference to FIG. 1A, an example framework 100 for the method and system described herein (sometimes referred to herein as the analytical tool REX) is illustrated. The method and systems is capable of analyzing the operating envelope of a nuclear reactor. For example, the method and system can be used to model nuclear reactor models while taking into account candidate materials and geometries and to provide an assessment of mechanical and allowable cladding stresses. As described below, the output of the method and system can be used to expand the operating envelope of a nuclear reactor. This is not a possibility using conventional tools. At step 110, reactor input parameters can be received corresponding to a reactor core including a first fuel-cladding material. The reactor input parameters can include geometric parameters, coolant parameters, fuel parameters, and/or neutronic parameters. Non-limiting examples of input parameters including the geometry, the coolant properties, fuel properties, and Serpent output (e.g., neutronic properties) are illustrated in FIG. 2A. Optionally, non-limiting examples of geometric parameters include one or more of a fuel radius, a cladding thickness, an active core height, a plenum height, a pin pitch, an assembly coolant channel radius or apothem, a number of assemblies, or a number of fuel pins per assembly. Optionally, non-limiting examples of coolant parameters include one or more of a mass flow rate, a coolant inlet temperature, a coolant boiling point, or a coolant inlet pressure. Optionally, non-limiting examples of fuel parameters include one or more of a theoretical fuel density or a fuel cycle length. Optionally, non-limiting examples of neutronic parameters include one or more of an axially discretized pin fission rate, a core nominal power, a fuel and fission product isotropic inventory as a functions of depletion, or a number of depletion steps.

At step 120, thermo-hydraulic and thermo-mechanical calculations 105 can be performed for each of the depletion steps in a fuel cycle. The thermo-hydraulic and thermo-mechanical calculations 105, which are shown by the dashed box in FIG. 1A, can include pin-specific calculations of one or more of coolant, cladding, and fuel temperature profiles; fuel deformations; cladding deformations; or pressures at the coolant-cladding, fuel-cladding, and gas-clad interfaces. The thermo-hydraulic and thermo-mechanical calculations 105 for the reactor core having the first fuel-cladding material can be based on the reactor input parameters.

At step 130, the thermo-hydraulic and thermo-mechanical calculations 105 can be repeated for a number of coolant inlet temperatures to obtain a plurality of operating envelope parameters associated with the reactor core having the first fuel-cladding material. Optionally, the operating envelope parameters are indexed to an assembly, a fuel pin, an axial zone, a depletion step, and a coolant inlet temperature. Non-limiting examples of operating envelope parameters that can be associated with the reactor core are illustrated in FIG. 2B. For example, the operating envelope parameters can include one or more of temperature parameters, pressure parameters, fuel deformation parameters, cladding deformation parameters, or mechanics parameters. Optionally, non-limiting examples of temperature parameters include one or more of a coolant outlet temperature, a coolant bulk temperature, a cladding inner surface temperature, a cladding outer surface temperature, a fuel surface temperature, a fuel centerline temperature, or a fuel average temperature. Optionally, non-limiting examples of pressure parameters include one or more of a fuel-cladding interface pressure, a fuel-gas interface pressure, or a coolant-cladding interface pressure. Optionally, non-limiting examples of fuel deformation parameters include one or more of a thermal expansion, a relocation densification, a swelling due to fission products, an elasticity, or a creep. Optionally, non-limiting examples of cladding deformation parameters include thermal expansion. Optionally, non-limiting examples of mechanics parameters include one or more of a maximum allowable cladding stress or an effective cladding stress.

As shown in FIG. 1A, at step 120, the thermo-hydraulic and thermo-mechanical calculations 105 are iteratively performed for a plurality of depletion steps in the fuel cycle. Once the thermo-hydraulic and thermo-mechanical calculations 105 are performed for the final depletion step in the fuel cycle, the coolant inlet temperature is increased by a predetermined amount, e.g., 50 K. It should be understood that 50 K is provided only as example predetermined amount. This disclosure contemplates that coolant inlet temperature can be increased by more or less than 50 K. Thereafter, at step 130, the thermo-hydraulic and thermo-mechanical calculations 105 are again iteratively performed for the plurality of depletion steps in the fuel cycle. Once the thermo-hydraulic and thermo-mechanical calculations 105 are performed for the final depletion step in the fuel cycle, the coolant inlet temperature is again increased by a predetermined amount, e.g., 50 K. This process (i.e., steps 120 and 130) is repeated until the maximum coolant outlet temperature is expected to exceed either the coolant boiling point or the cladding temperature limit at the next iteration. The result of this iterative process is the plurality of operating envelope parameters associated with a nuclear reactor. For example, such result is 5-D operating envelope parameters (e.g., temperature, pressure, fuel deformation, cladding deformation, and mechanics parameters), which are optionally indexed to an assembly, a fuel pin, an axial zone, a depletion step, and a coolant inlet temperature, associated with the nuclear reactor having the first fuel-cladding material.

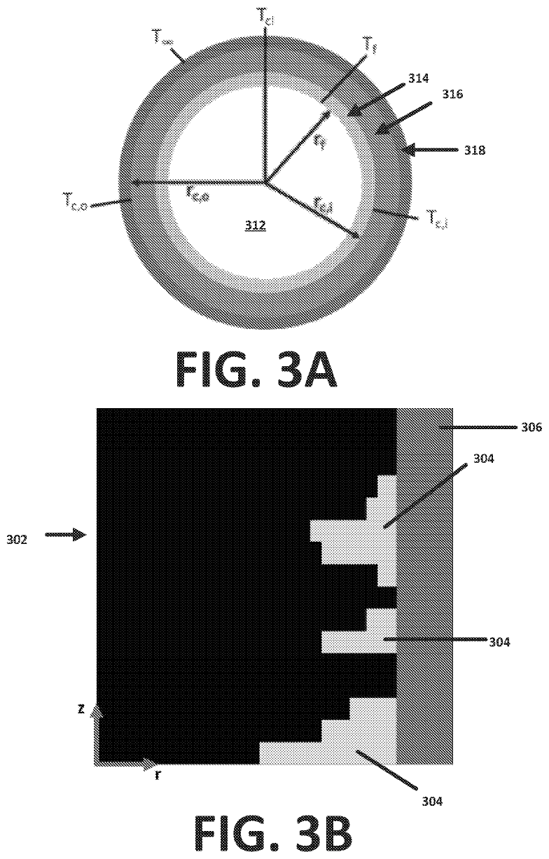

After completing steps 120 and 130, the fuel pin geometry of the reactor core including the first fuel-cladding material can be modified at step 140. In some implementations of the present disclosure, fuel pin geometry can include one or more of a fuel-cladding gap width or a cladding thickness. FIG. 3A illustrates geometry of a fuel element, also referred to herein as a fuel pin, including fuel 312, gap 314, cladding 316 and coolant 318. FIG. 3B illustrates another example fuel geometry, including void-closure treatment of radial fuel swelling and fuel-clad gap closure in discrete axial zones. FIG. 3B also shows fuel 302, gap 304, and cladding 306.

Step 120 can then be repeated for the reactor core having the first fuel-cladding material and modified fuel pin geometry. In other words, the thermo-hydraulic and thermo-mechanical calculations 105 are performed for each of the depletion steps in a fuel cycle but this time for the reactor core having the first fuel-cladding material and modified fuel pin geometry. Additionally, step 130 can then be repeated for a number of coolant inlet temperatures. In other words, the thermo-hydraulic and thermo-mechanical calculations 105 are repeated for a number of coolant inlet temperatures but this time for the reactor core having the first fuel-cladding material and modified fuel pin geometry. As a result, a plurality of operating envelope parameters associated with the reactor core having the first fuel-cladding material and modified fuel pin geometry are obtained. As described above, this process (i.e., steps 120 and 130) is repeated for the reactor core having the first fuel-cladding material and modified fuel pin geometry until the maximum coolant outlet temperature is expected to exceed either the coolant boiling point or the cladding temperature limit at the next iteration. The result of this iterative process is the plurality of operating envelope parameters (e.g., 5-D operating envelope parameters) associated with the reactor core having the first fuel-cladding material and modified fuel pin geometry.

After completing steps 120 and 130 for the reactor core having the first fuel-cladding material and modified fuel pin geometry, the fuel-cladding material is modified (e.g., from a first fuel-cladding material to a second fuel-cladding material) at step 150. Step 120 can then be repeated for the reactor core having the second fuel-cladding material and modified fuel pin geometry. In other words, the thermo-hydraulic and thermo-mechanical calculations 105 are performed for each of the depletion steps in a fuel cycle but this time for the reactor core having the second fuel-cladding material and modified fuel pin geometry. Additionally, step 130 can then be repeated for a number of coolant inlet temperatures. In other words, the thermo-hydraulic and thermo-mechanical calculations 105 are repeated for a number of coolant inlet temperatures but this time for the reactor core having the second fuel-cladding material and modified fuel pin geometry. As a result, a plurality of operating envelope parameters associated with the reactor core having the second fuel-cladding material and modified fuel pin geometry are obtained. As described above, this process (i.e., steps 120 and 130) is repeated for the reactor core having the second fuel-cladding material and modified fuel pin geometry until the maximum coolant outlet temperature is expected to exceed either the coolant boiling point or the cladding temperature limit at the next iteration. The result of this iterative process is the plurality of operating envelope parameters (e.g., 5-D operating envelope parameters) associated with the reactor core having the second fuel-cladding material and modified fuel pin geometry.

After completing steps 120 and 130 for the reactor core having the first fuel-cladding material and modified fuel pin geometry, the fuel-cladding material is modified (e.g., from a first fuel-cladding material to a second fuel-cladding material). Step 120 can then be repeated for the reactor core having the second fuel-cladding material and modified fuel pin geometry. In other words, the thermo-hydraulic and thermo-mechanical calculations 105 are performed for each of the depletion steps in a fuel cycle but this time for the reactor core having the second fuel-cladding material and modified fuel pin geometry. Additionally, step 130 can then be repeated for a number of coolant inlet temperatures. In other words, the thermo-hydraulic and thermo-mechanical calculations 105 are repeated for a number of coolant inlet temperatures but this time for the reactor core having the second fuel-cladding material and modified fuel pin geometry. As a result, a plurality of operating envelope parameters associated with the reactor core having the second fuel-cladding material and modified fuel pin geometry are obtained. As described above, this process (i.e., steps 120 and 130) is repeated for the reactor core having the second fuel-cladding material and modified fuel pin geometry until the maximum coolant outlet temperature is expected to exceed either the coolant boiling point or the cladding temperature limit at the next iteration. The result of this iterative process is the plurality of operating envelope parameters (e.g., 5-D operating envelope parameters) associated with the reactor core having the second fuel-cladding material and modified fuel pin geometry.

At step 160, it can be determined whether the operating envelope of the reactor is expanded as a result of the change in fuel-cladding material by comparing the respective operating envelope parameters associated with the reactor core having the first fuel-cladding material and the reactor core having the second fuel-cladding material and the modified fuel pin geometry. Optionally, the operating envelope parameters (e.g., those associated with the first reactor design, second reactor design, or both reactor design) can be stored in memory and/or output, for example, on a graphical display. Optionally, information about operating envelope of the reactor expansion can be used in the assessment of reactor design, upgrades, operating conditions, safety, life, etc. In some implementations, information about operating envelope of the reactor expansion is used in the assessment of reactor design, for example, to design a reactor with expanded operating envelope based on modified fuel-cladding material and/or fuel pin geometry.

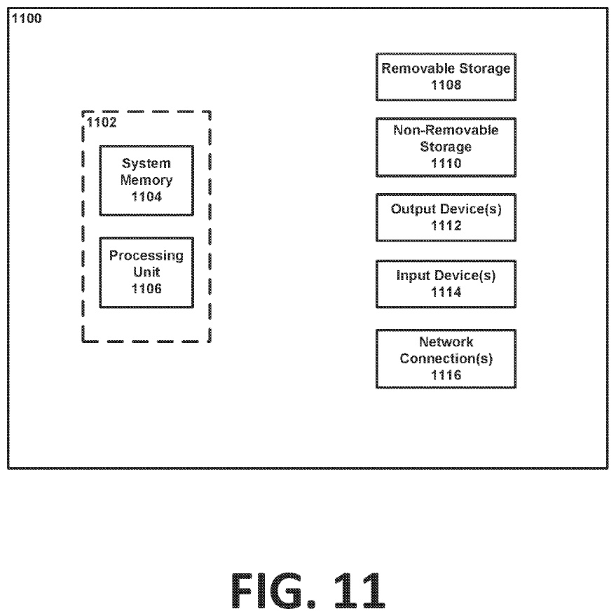

It should also be understood that system and method illustrated in FIG. 1A can be implemented as part of a system, or a computer readable medium, for example using the computing device 1100 illustrated in FIG. 11.

With reference to FIG. 1B, another implementation of the present disclosure includes a computer implemented method for analyzing an operating envelope of a nuclear reactor.

At step 152, a plurality of operating envelope parameters associated with a first reactor core are obtained by performing a plurality of thermo-hydraulic and thermo-mechanical calculations for the first reactor core, where the first reactor core includes a first fuel-cladding material and has a first fuel pin geometry. Thermo-hydraulic and thermo-mechanical calculations are described above, for example, the calculations 105 shown in dashed box of FIG. 1A. For example, the thermo-hydraulic and thermo-mechanical calculations can include pin-specific calculations of one or more of coolant, cladding, and fuel temperature profiles; fuel deformations; cladding deformations; or pressures at the coolant-cladding, fuel-cladding, and gas-clad interfaces. Such thermo-hydraulic and thermo-mechanical calculations can be iteratively performed for each of a plurality of fuel depletion steps in the fuel cycle and also for each of a plurality of plurality of coolant inlet temperatures. The result of this iterative process is the plurality of operating envelope parameters associated with the first reactor core having the first fuel-cladding material and the first fuel pin geometry. For example, such result is 5-D operating envelope parameters (e.g., temperature, pressure, fuel deformation, cladding deformation, and mechanics parameters) associated with the first reactor core having the first fuel-cladding material and the first fuel pin geometry. Optionally, these operating envelope parameters are optionally indexed to an assembly, a fuel pin, an axial zone, a depletion step, and a coolant inlet temperature.

At step 154, a plurality of operating envelope parameters associated with a second reactor core are obtained by performing a plurality of thermo-hydraulic and thermo-mechanical calculations for the second reactor core, where the second reactor core includes a second fuel-cladding material and has a second fuel pin geometry. As described herein, the first and second fuel-cladding materials are different materials. Additionally, the first and second fuel pin geometries used in steps 152 and 154, respectively can be the same or different. Similarly to step 152, the thermo-hydraulic and thermo-mechanical calculations of step 154 can be iteratively performed for each of a plurality of fuel depletion steps in the fuel cycle and also for each of a plurality of plurality of coolant inlet temperatures. The result of this iterative process is the plurality of operating envelope parameters associated with the second reactor core having the second fuel-cladding material and the second fuel pin geometry. For example, such result is 5-D operating envelope parameters (e.g., temperature, pressure, fuel deformation, cladding deformation, and mechanics parameters) associated with the second reactor core having the second fuel-cladding material and the second fuel pin geometry. Optionally, these operating envelope parameters are optionally indexed to an assembly, a fuel pin, an axial zone, a depletion step, and a coolant inlet temperature.

At step 156 the operating envelope is assessed by comparing the respective operating envelope parameters associated with the first reactor core and the second reactor core obtained in steps 152 and 154. Optionally, the operating envelope parameters (e.g., those associated with the first reactor design, second reactor design, or both reactor design) can be stored in memory and/or output, for example, on a graphical display. Optionally, information about operating envelope of the reactor expansion can be used in the assessment of reactor design, upgrades, operating conditions, safety, life, etc. In some implementations, information about operating envelope of the reactor expansion is used in the assessment of reactor design, for example, to design a reactor with expanded operating envelope based on modified fuel-cladding material and/or fuel pin geometry.

Additionally, the present disclosure contemplates that the method 150 illustrated in FIG. 1B can be implemented as a computer implemented method, or as part of a system including a processor and a memory, or as a non-transitory computer readable medium. The computing device 1100 can be used to implement the computer implemented method, system, or non-transitory computer readable medium according to these various example implementations of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

This example introduces and describes an implementation of the present disclosure called “REX.” REX includes an analytical reactor design tool developed to compare the operating envelopes of advanced reactor designs outfitted with a variety of candidate cladding materials. Aspects of the REX implementation were developed in MATLAB, although it should be understood that different computer programming languages and different types of computer hardware can be used to implement different implementations of the present disclosure, for example any of the types of computer hardware and programming languages described with reference to FIG. 11. REX performs a sequence of core-wide, pin-specific thermal-hydraulic and thermo-mechanical calculations to determine the mechanical stresses experienced by a candidate cladding material, manipulate fuel pin geometries to the point where these stresses prohibit reactor operation, then test the performance of alternative cladding materials under originally prohibitive conditions. REX considers discrete axial fuel subdivisions, which are then further discretized into radially concentric rings [7]. This 1.5-dimensional discretization is used to calculate coolant, cladding, and fuel temperature profiles, fuel and cladding deformations, and pressures at the coolant-clad, fuel-clad, and gas-clad interfaces. Once this calculation is completed for every fuel pin in the core, REX moves on to the next depletion step and repeats the calculation. At the end of the fuel cycle, REX will increase the coolant inlet temperature by a specified quantity, and repeat the entire fuel cycle calculation sequence to retrieve a pushed operating envelope. Once it reaches a maximum allowable coolant inlet temperature, REX seeks out mechanical failure of the original cladding by modifying fuel pin geometries to the point where cladding effective stresses exceed the maxi-mum allowable stress, which is selected as the yield strength for ductile materials, and fracture stress for brittle materials. The original cladding is then replaced with an alternative cladding material, and the thermal-hydraulic and thermo-mechanical calculations are repeated with the new fuel pin geometries. Survival of an alternative cladding material under the same set of conditions that resulted in failure of the original material suggests operating envelope expansion.

REX Methodology Overview: REX uses several input parameters to perform a series of pin-specific thermo-hydraulic and thermo-mechanical calculations. The inputs for REX are detailed in FIG. 2A. Among these inputs are pin-specific fission rates retrieved from Serpent 2, a three-dimensional, continuous energy, Monte Carlo neutron transport code [10]. REX normalizes these fission rates with the core nominal power to produce effective pin fission powers indexed to each assembly, fuel pin, and axial zone. An additional index, the depletion step, is produced if the built-in depletion capability of Serpent 2 is used. After all thermal-hydraulic and thermo-mechanical calculations are completed for the final depletion step, the coolant inlet temperature is increased by 50 K and the entire sequence is repeated from the initial depletion step. This iterative sequence is repeated until the maximum coolant outlet temperature is expected to exceed either the coolant boiling point or the cladding temperature limit at the next iteration. The result of this iterative sequence is a set of 5-D operating envelope parameters indexed to assembly, fuel pin, axial zone, depletion step, and coolant inlet temperature. The complete list of parameters calculated by REX is provided in FIG. 2B.

After collecting these 5-D variables, REX performs a series of checks described below, and dynamically modifies the fuel-clad gap width and cladding thickness. The cold fuel radius is never modified in order to preserve the neutronics from the initial Serpent simulation. REX then determines the operating envelope of the reactor with the modified fuel pin geometries, then repeats the checks and adjustments. This iterative sequence is cycled until the effective stress on the original cladding material exceeds its maximum allowable stress at only the final depletion and coolant in-let temperature steps, ensuring the operational limit of the original cladding is reached. REX then replaces the original cladding with specified alternative materials and evaluates the reactor thermo-mechanics with the new cladding materials and fuel pin geometries.

The REX approach is summarized in FIG. 1A.

Subchannel Temperatures: REX divides each subchannel in the reactor core into discrete axial segments, with the number of axial zones defined by the detector inputs in the corresponding Serpent model. In each axial volume, REX calculates the temperatures listed in FIG. 2B by assuming 1-D heat conduction across the fuel element. The fuel pin and its labeled regions are illustrated in FIG. 3A. The temperature of the bulk coolant, cladding outer surface, cladding inner surface, fuel surface, and fuel centerline are labeled as T_{∞}, T_{co}, T_{ci}, T_{f}, and T_{cl}, respectively.

REX makes the following assumptions in calculating subchannel temperatures:

(1) No heat conduction occurs in the axial direction. This is due to the fact that the temperature gradient in a fuel pin is much higher in the radial direction than in the axial direction [11].

(2) Power density within an axial zone is uniform across the fuel radius.

(3) No crossflow: coolant only flows axially upward in an assembly.

REX calculates T_{∞}, T_{co}, and T_{ci} with Eqns. 1-3 and the aforementioned assumptions for each axial segment:

$${T}_{∞} = \frac{{T}_{cool , in}}{2} ( 1 + \frac{{q}^{′′′} V}{{\dot{m}}_{s u b} {c}_{p}} ) \qquad ( 1 )$$

$${T}_{c o} = \frac{1}{2} \frac{{r}_{f}^{2} {q}^{′′′}}{{r}_{c o} h} + {T}_{∞} \qquad ( 2 )$$

$${T}_{c i} = \frac{{r}_{f}^{2} {q}^{′′′} log ( \frac{{r}_{c o}}{{r}_{c i}} )}{2} + {T}_{c o} \qquad ( 3 )$$

where q′″ is the power density, V is the fuel volume, \dot{m}_{sub} is the mass flow rate of the coolant in the subchannel, cₚ is the coolant isobaric specific heat, T_{cool,in} is the coolant inlet temperature, r_{f} is the fuel radius, h is the convective heat transfer coefficient of the coolant, r_{co} and r_{ci} are the cladding outer and inner radii, respectively, and k_{clad} is the thermal conductivity of the cladding.

If a fuel-clad gap exists, REX assumes it is occupied by a mixture of a fill gas and fission product gases that appear with burnup. The identity of the fill gas is specified as input, whereas the fission product gases are retrieved from Serpent depletion output. Heat transfer from the cladding inner surface to the fuel surface through this gas mixture is modeled as a combination of conduction and radiation [12]. The heat transfer coefficient through the gap is calculated as

$${h}_{g} = \frac{{k}_{g a s}}{{δ}_{eff}} + \frac{σ}{\frac{1}{{ε}_{f}} + \frac{1}{{ε}_{c}} - 1} \frac{{T}_{f}^{4} - {T}_{c i}^{4}}{{T}_{f} - {T}_{c i}} \qquad ( 4 )$$

where k_{gas} is the thermal conductivity of the gap gas mixture, δ_{ef f} is the effective gap width, σ is the StefanBoltzmann constant, εᵣ and ε_{c} are the fuel and cladding emissivities, respectively, and T_{f} is the fuel surface temperature. δ_{eff} is slightly larger than the real gap width due to jump discontinuities in temperature at the fuel-gas and clad-gas interfaces. It is typically modeled as:

$${δ}_{eff} = {δ}_{g} + {δ}_{j u m p , f} + {δ}_{jump , ci} \qquad ( 5 )$$

where δ_{g} is the true gap width and δ_{jump,f} and δ_{jump,ci} are the gas temperature jump distances at the fuel and inner cladding surfaces, respectively. Gap conductance can also be stated as a function of heat flux, q″, through the gap:

$${h}_{g} = \frac{{q}^{″}}{{T}_{f} - {T}_{c i}} = \frac{{q}^{′′′}}{{T}_{f} - {T}_{c i}} \frac{{r}_{f}}{2} \qquad ( 6 )$$

REX numerically solves Eqns. 4 and 6 for the fuel surface temperature, T_{f} in the presence of a fuel-clad gap.

If a fuel-clad gap is closed or not modeled, REX determines the fuel surface temperature with conduction through an annular surface:

$${T}_{f} = \frac{{r}_{f}^{2} {q}^{′′′}}{2} \frac{log ( \frac{{r}_{c o}}{r f} )}{{k}_{c l a d}} + {T}_{c o} \qquad ( 7 )$$

REX determines T_{cl} by dividing the cross section of the fuel into N discrete radial segments, each with a uniform power density, equal volume, and constant thermal conductivity. The temperature T_{seg} of each radial segment R_{seg} is determined with Eqn. 8:

$${T}_{s e g + 1} = \frac{1}{4} \frac{{q}^{′′′}}{{k}_{fuel}} ( {R}_{s e g}^{2} - {R}_{s e g + 1}^{2} ) + {T}_{s e g} \qquad ( 8 )$$

where k_{fuel} is the thermal conductivity of the fuel, which REX calculates as a function of porosity, dissolved solid fission products effects, irradiation damage, burnup, and temperature. This iteration has the following boundary conditions:

$${T}_{s e g} = \{ \begin{matrix}{T}_{f} , & if seg = 1 \\ {T}_{cl} , & if seg = N\end{matrix}$$

$$and$$

$${R}_{s e g} = \{ \begin{matrix}{r}_{f} , & if seg = 1 \\ 0 , & if seg = N\end{matrix}$$

REX stores the temperatures of every radial fuel segment and uses them to calculate the average fuel temperature, which is used in fission product gas pressure and fuel deformation calculations.

Subchannel Coolant Pressure Losses: Coolant pressures deliver stresses to the cladding at the coolant-clad interface. These pressures experience losses due to acceleration, gravity, and friction as the coolant travels axially through the active region of the core. REX calculates these pressure losses according to [13]. Form losses are also considered and calculated on a case-by-case basis for each reactor design. Presently, REX exclusively considers pressure losses for single-phase coolants traversing axial active regions.

In reactors kept at atmospheric pressure, REX initializes coolant pressure at the inlet of the axial zone as a combination of atmospheric and hydrostatic pressures:

$${P}_{cool , in} = {P}_{a t m} + \overline{ρ} g Δ L \qquad ( 9 )$$

where Pₐₜₘ is atmospheric pressure, p is the average density of the coolant at the inlet and outlet of the axial zone, g is the acceleration due to gravity, and ΔL is the distance from the top of the core to the midplane of the subchannel axial zone.

First, subchannel coolant pressure losses due to axial deceleration are determined with Eqn. 10:

$$- Δ {P}_{a c c l} = \frac{\overline{ρ}}{2} ( {v}_{o u t}^{2} - {v}_{i n}^{2} ) \qquad ( 10 )$$

where vₒᵤₜ and vᵢₙ are the inlet and outlet velocities of the coolant in the axial zone.

Next, REX calculates gravitational pressure losses with Eqn. 11:

$$- Δ {P}_{grav} = \overline{ρ} g Δ z \qquad ( 11 )$$

where Δz is the height of the axial zone. This quantity will vary as the fuel swells axially.

Third, pressure losses due to friction are calculated with Eqn. 12:

$$- Δ {P}_{fric} = f \frac{Δ z}{{D}_{e}} \frac{\overline{ρ} {\overline{v}}^{2}}{2} \qquad ( 12 )$$

where v̅ is the average coolant velocity in the axial zone, Dₑ is the subchannel equivalent diameter, and f is the flow friction factor. REX calculates f in each axial zone as a function of the average Reynolds number R̅e̅ with the Blasius and McAdams correlations [14].

$$f = \{ \begin{matrix}\frac{64}{\overline{Re}} , & \overline{Re} < 2200 \\ 0.3 \; 16 {\overline{Re}}^{- 0.25} , & \overline{Re} < 30 , 000 \\ 0.1 \; 84 {\overline{Re}}^{- 0.20} , & \overline{Re} > 30 , 000\end{matrix} \qquad ( 13 )$$

The three pressure loss terms calculated in Eqns. 10-12 are combined for a total pressure loss:

$$Δ {P}_{total} = Δ {P}_{a c c l} + Δ {P}_{grav} + Δ {P}_{fric} \qquad ( 14 )$$

REX calculates these pressure losses for every axial zone in every subchannel in the core. The resulting axial pressure profile is used in conjunction with fission product gas pressure and fuel-clad interfacial pressure to determine the effective stress experienced by the cladding.

Fission Product Gas Release and Pressure: As the molecular composition of the fuel changes at high temperature, accumulated fission product gases are released into the fuel-clad gap (if one exists) and the gas plena and pressurize the cladding inner surface. The number of fission product gas atoms produced in every fuel pin as a function of depletion is retrieved from the depletion output produced by Serpent. In the case of UO₂ fuel, REX estimates the release fraction of these particles from the entire fuel pin with the following empirical relation

$${f}_{release} = \{ \begin{matrix}0.05 , & T < 1400 ° C . \\ 0.10 , & 1400 °C < T < 1500 ° C . \\ 0.20 , & 1500 °C < T < 1600 ° C . \\ 0.40 , & 1600 °C < T < 1700 ° C . \\ 0.60 , & 1700 °C < T < 1800 ° C . \\ 0.80 , & 1800 °C < T < 2000 ° C . \\ 0.98 , & T > 2000 ° C .\end{matrix} \qquad ( 15 )$$

where T is the average fuel pin temperature.

The pressure due to the mixture of fission product gases and the fuel-clad gap fill gas affects the fuel elastic deformations observed during closed fuel-clad gap scenarios [16].

REX determines this fuel-gas interfacial pressure for every event of fuel-clad gap closure in the fuel pin. For this calculation, a continuous cluster of axial zones in which the fuelclad gap has been closed is treated as a single closure and each cluster of non-closures is deemed a void. REX assumes gas particles are distributed into each void, proportional to the void volume, and calculates the gas pressure in each void with the ideal gas law:

$${P}_{g a s} = \frac{{N}_{g a s} {k}_{B} T}{{V}_{v o i d}} \qquad ( 16 )$$

where N_{gas}=N_{FP}+N_{fill} is the number of fission product and fill gas particles in the void, T is the average temperature of the pin, k_{B} is the Boltzmann constant, and V_{void} is the volume of the void. The fuel slice at the border of each void-closure interface is then assumed to experience the gas pressure in its respective void. In the event of complete fuel-clad gap closure, as is the case in later depletion steps, all of the gas is assumed to reach the upper and lower gas plena and pressurize the axial top and bottom fuel surfaces. This void-closure treatment is illustrated in FIG. 3B.

Thermo-Mechanics and Fuel Deformation: REX calculates radial and axial fuel swelling due to the following mechanisms: thermal expansion, cracking due to thermal stresses (termed relocation), densification, and swelling due to the appearance of solid and gaseous fission products. The rates of these swelling mechanisms depend on fuel composition. UO₂ fuel deformation has been incorporated into REX. Fuel deformations due to thermal expansion and relocation are calculated as linear strains and are applied to the fuel radius and height at each axial zone. Densification and swelling due to fission products, however, are volumetric strains and are calculated for entire fuel pins.

Cladding Thermal Expansion: REX also considers radial and linear swelling of the cladding material due to thermal expansion with the canonical formula:

$${( \frac{Δ L}{L} )}_{clad} = {{α}_{c l a d} ( Δ T )}_{c l a d} \qquad ( 17 )$$

where α_{clad} is the coefficient of thermal expansion of the cladding, (ΔT)_{clad} is the change in cladding temperature at each depletion step, and

$${( \frac{Δ L}{L} )}_{clad}$$

is the fractional change in length of the cladding material.

Fuel-Clad Mechanical Interactions and the Soft Pellet Model: REX considers the fuel and cladding to be in “hard contact” after two conditions are met:

Condition 1: Fuel fully traverses the fuel-clad gap.

Condition 2: 50% of the fuel relocation strain is recovered by the combination of fuel and cladding radial strains.

At hard contact, REX quantifies pellet-clad mechanical interactions (PCMI) with the Soft Pellet Model, an iterative sequence that yields fuel-clad interfacial pressure for cladding stress calculations [16]. The model starts with two continuity conditions. First, radial continuity dictates that fuel and cladding radial displacements must be equal. Second, axial continuity requires that additional axial strain in the fuel is transferred entirely to the cladding. These conditions are described by Eqns. 18 and 19, respectively:

$$Radial continuty : {u}_{{f}_{o}} = {u}_{c i} \qquad ( 18 )$$

$$Axial continuity : {ε}_{Z}^{c l a d} - {ε}_{z , 0}^{clad} = {ε}_{z}^{fuel} - {ε}_{z , 0}^{fuel} \qquad ( 19 )$$

where u_{fo} is the outer radial displacement of the fuel, u_{ci} is the inner radial displacement of the cladding, ε_{z} denotes axial strain, and ε_{z,0} denotes axial strain at contact. REX uses these conditions to determine the tangential (hoop) stress on the cladding, assuming the cladding is a thin-walled cylindrical shell:

$${σ}_{θ} = \frac{E ( 2 {u}_{c i} - {ε}_{z} v ( t - 2 \tilde{r} ) )}{2 \tilde{r} + v ( t + v t + 2 \tilde{r} v )} \qquad ( 20 )$$

where E is the elastic modulus of the cladding material, v is the Poisson ratio of the cladding material, t is the thickness of the cladding, and

$$\tilde{r} = \frac{{r}_{c o} + {r}_{c i}}{2} . REX$$

uses the cladding hoop stress to obtain an initial guess at the fuel-clad interfacial pressure:

$${P}_{i n t} = \frac{t {σ}_{θ} + {r}_{c o} {P}_{c o o l}}{{r}_{c i}} \qquad ( 21 )$$

where P_{cool} is the coolant pressure in the axial zone. Fuel-clad interfacial pressures induce plastic deformations in the fuel (hence the name, “Soft Pellet Model”). REX calculates the radial and axial components of this strain with Eqns. 22 and 23:

$${ε}_{rf} = \frac{{v}_{f} {P}_{g a s} - {P}_{i n t}}{{E}_{f}} \qquad ( 22 )$$

$${ε}_{z f} = \frac{{v}_{f} {P}_{i n t} - {P}_{g a s}}{{E}_{f}} \qquad ( 23 )$$

where ε_{rf} and ε_{zf} are the radial and axial elastic fuel strains due to PCMI, P_{gas} is the fuel-gas interfacial pressure described herein, Pᵢₙₜ is the fuel-clad interfacial pressure, E_{f} is the fuel elastic modulus, and v_{f} is the fuel Poisson ratio. With these parameters, REX completes its first iteration of the Soft Pellet Model by calculating the additional fuel radial displacement due to elastic deformations:

$${u}_{f o} = {r}_{f} {ε}_{rf} \qquad ( 24 )$$

REX then loops through Eqns. 18-24 until it converges on a solution for the fuel-clad interfacial pressure, Pᵢₙₜ, for the current axial zone.

REX uses the coolant-clad, gas-clad, and fuel-clad interfacial pressures determined herein to determine the radial, tangential, and axial stresses experienced by the cladding [17]:

$${σ}_{rc} = \frac{{P}_{i n t} {r}_{f}^{2} - {P}_{c o o l} {r}_{c o}^{2} + \frac{{r}_{f}^{2} {r}_{c o}^{2} ( {P}_{c o o l} - {P}_{i n t} )}{{r}^{2}}}{{r}_{c o}^{2} - {r}_{f}^{2}} \qquad ( 25 )$$

$${σ}_{θ c} = \frac{{P}_{i n t} {r}_{f}^{2} - {P}_{c o o l} {r}_{c o}^{2} \frac{{r}_{f}^{2} {r}_{c o}^{2} ( {P}_{c o o l} - {P}_{i n t} )}{{r}^{2}}}{{r}_{c o}^{2} - {r}_{f}^{2}} \qquad ( 26 )$$

$${σ}_{z c} = \frac{{P}_{i n t} {r}_{f}^{2} - {P}_{c o o l} {r}_{c o}^{2}}{{r}_{c o}^{2} - {r}_{f}^{2}} \qquad ( 27 )$$

where σ_{rc}, σ_{θc}, and σ_{zc} are the radial, tangential, and axial stresses experienced by the cladding at the current axial zone. r is the radial point where the stress is evaluated, which is chosen to be r_{f}. REX combines these three stress components to calculate the effective stress delivered to the cladding with the Von Mises equation:

$${σ}_{e} = \sqrt{\frac{{( {σ}_{z c} - {σ}_{θ c} )}^{2} + {( {σ}_{θ c} - {σ}_{r c} )}^{2} + {( {σ}_{r c} - {σ}_{z c} )}^{2}}{2}} \qquad ( 28 )$$

REX compares this effective stress to the maximum allowable stress, which is a function of the cladding material. To identify the base operating envelope of the reactor with the original cladding material, REX will manipulate fuel pin geometries to ensure that the effective stress exceeds the maximum allowable stress at the final depletion step and maximum allowable coolant inlet temperature. This manipulation is described throughout the present disclosure.

Adjustments to Fuel Pin Geometry: At the end of its calculation for the reactor outfitted with the original cladding material, REX locates the fuel pin that experiences the most swelling and determines the following:

Predicted fuel swelling past the cladding outer wall:

$$Δ {r}_{c x} = {r}_{f} - {r}_{c o}$$

Excess fuel swelling beyond the gap:

$$Δ {r}_{g x} = {r}_{f} - {r}_{c i}$$

Excess cladding stress:

$$Δ {σ}_{x} = {σ}_{e} - {σ}_{lim}$$

where σₗᵢₘ is the stress limit of the cladding. REX uses these three parameters to perform a series of checks and adjustments to the fuel pin geometries:

1. If Δr_{cx}>0, the fuel-clad gap is extended to accommodate the excess fuel swelling.

2. If Δr_{cx}<0, Δr_{gx}>0, and Δσₓ>0, the cladding thickness is extended.

3. If Δr_{cx}<0, Δr_{gx}>0, and Δσₓ<0, the cladding thickness is decreased.

4. If Δr_{gx}<0, the fuel-clad gap is decreased by 50% to force fuel-clad contact in the next iteration.

5. If several iterations result in the fuel-clad gap being decreased by 50%, REX will adjust the cladding thickness so that clad occupies nearly the entire fuel pin pitch. This adjustment potentially forces Δσₓ<0 for remaining iterations.

After an adjustment, REX repeats the entire calculation sequence to retrieve a new operating envelope with the updated fuel pin geometries. This iteration is repeated until REX determines the fuel pin geometries that give rise to a minimum positive value of Δσₓ at the end of the fuel cycle with maximum coolant inlet temperature. REX then uses these geometries to perform all thermal-hydraulic and thermo-mechanical calculations for the reactor outfitted with the alternative cladding materials and compares the effective and maximum allowable stresses for each case.

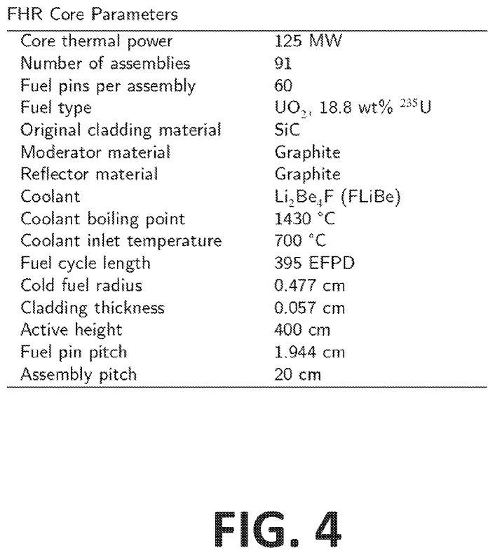

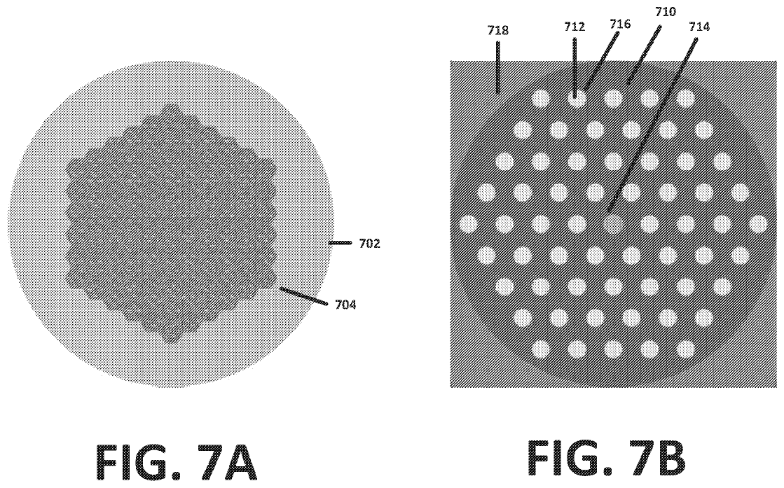

Example Analysis of a Fluoride Salt-Cooled High Temperature Reactor: REX was used to analyze and potentially expand the operating envelope of a small, pin-type fluoride salt-cooled high-temperature reactor (FHR). The FHR design is detailed in [18] and briefly summarized here. Non-limiting example core details are provided in FIG. 4 and an illustration of the FHR core and fuel assembly is shown in FIGS. 7A and 7B, where FIG. 7A illustrates an example core, showing a reflector 702 around the core 704. FIG. 7B illustrates a fuel assembly with coolant 710, fuel 712, cladding 716, and moderator 718. FIG. 7B also illustrates a tie rod 714.

The FHR in this example study had received preliminary coupled neutronic-thermal hydraulic analysis by [18]. The Li₂ Be₄ F(FLiBe)-cooled 125-MWt core contains 91 hexagonal fuel assemblies, each containing 60 solid cylindrical uranium dioxide (UO₂) fuel pins surrounded by silicon carbide (SiC) cladding. Each assembly is centered by a SiC tie rod, embedded in a graphite moderator matrix, and arranged in a hexagonal lattice surrounded by a cylindrical graphite reflector. This FHR had only previously received neutronic and preliminary thermal-hydraulic analysis; therefore, no fuel-clad gap was specified in design literature, rendering this FHR a suitable model for REX.

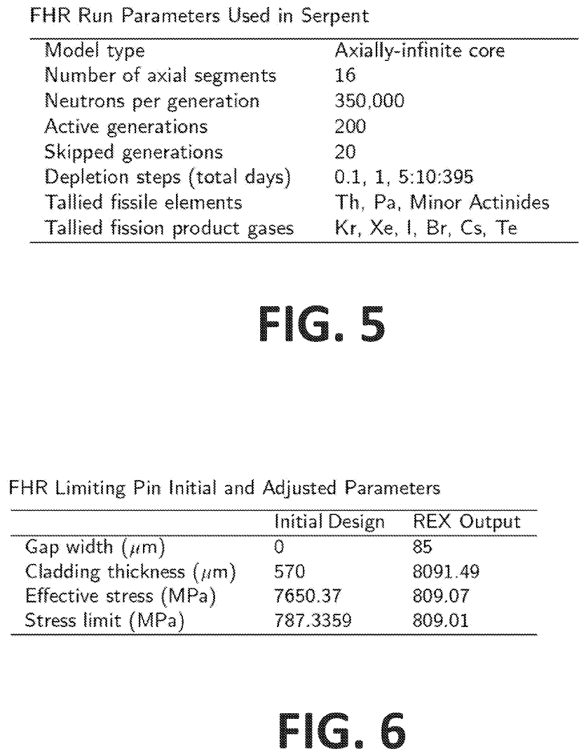

FHR Simulation: The neutronics of the small, 125-MWt FHR were simulated with the Serpent 2 Monte Carlo neutron transport code. Serpent was used to analyze an axially infinite core and score fission rates in 16 equally spaced axial zones along a height of 400 cm. Each of the 91 fuel assemblies are modeled with their own identical yet distinguishable fuel material for the collection of assembly-specific depletion statistics. The depletion steps and neutron population statistics for this simulation are presented in FIG. 5. Several depletion steps were simulated for precise evolution of the cladding stress profiles with time. All isotopes of thorium, palladium, and the minor actinides were tallied in each assembly for an accurate description of fuel evolution, which is used to compute burnup in atom percent, a necessary parameter for several correlations described above. Additionally, the inventory of fission products that appear as gases at FHR temperatures was collected for use in Eqn. 16.

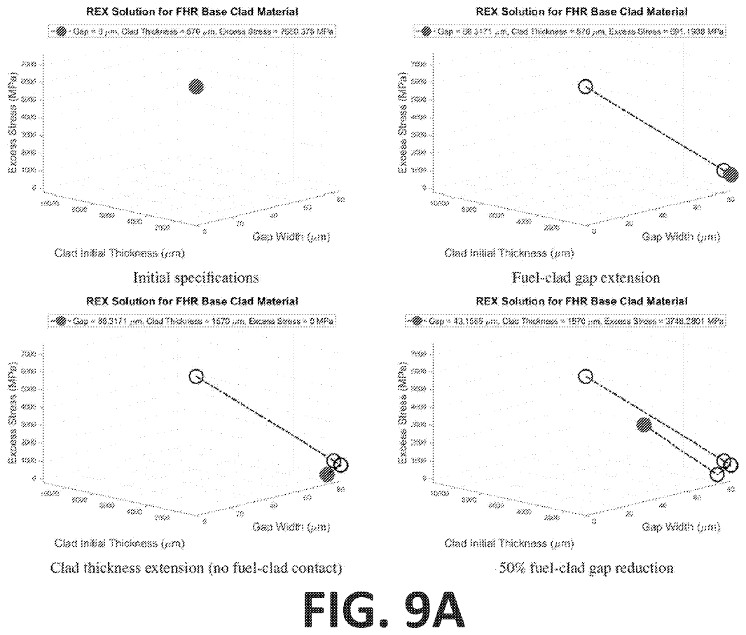

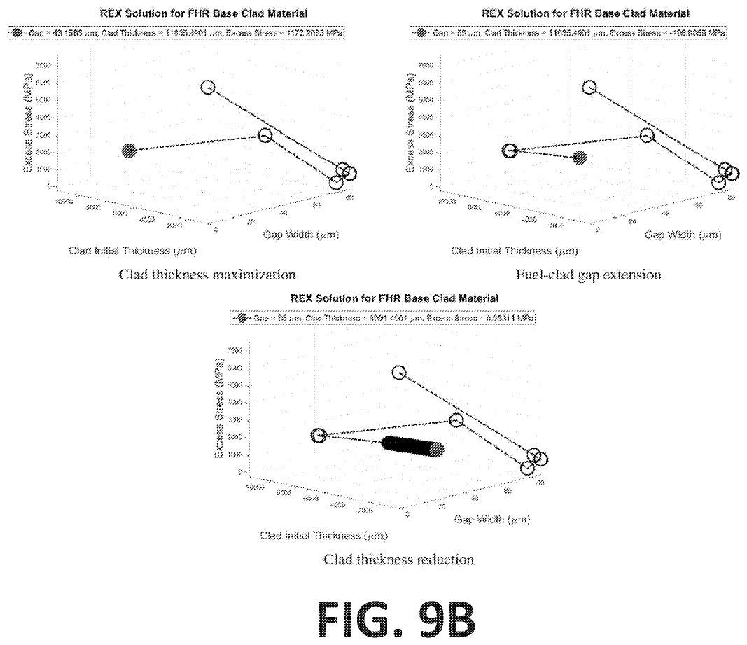

FHR Results: The adjustments made to the geometries of the limiting FHR fuel pin, as described above, are shown in FIGS. 9A-9B. REX automatically determines optimal initial values of fuel-clad gap width and cladding thickness for the limiting fuel pin to force a maximum effective stress that narrowly exceeds the SiC fracture stress. These final geometries and corresponding stresses are provided in FIG. 6.

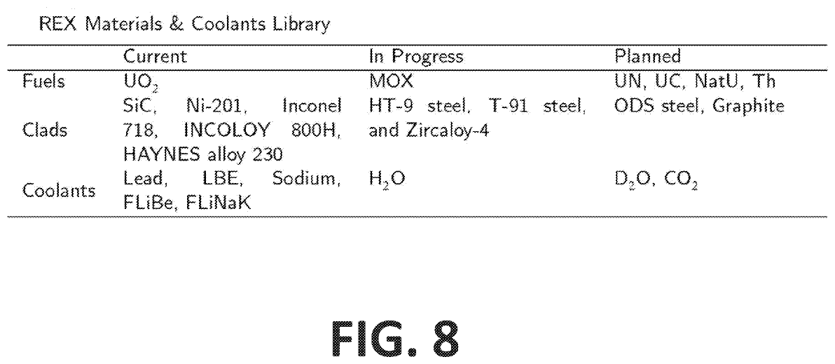

The effective and maximum allowable SiC stresses with these geometries are plotted in FIG. 7. Because SiC is a brittle material, its maximum allowable stress is its fracture strength [19]. The effective stress of the original cladding material, SiC, exceeds the maximum allowable stress at the final depletion step and maximum coolant inlet temperature, indicating that REX has identified the base operating envelope for this FHR with the limiting fuel pin geometries listed in FIG. 8.

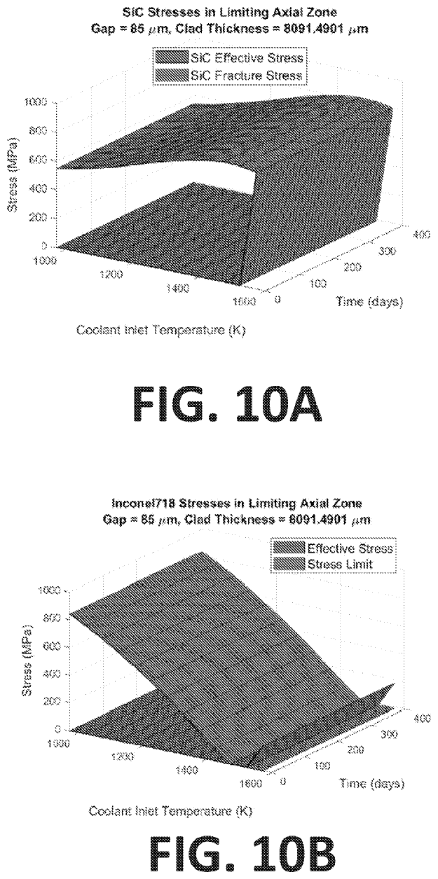

Finally, consider an alternative cladding material: Inconel 718, a nickel alloy. The mechanical response of this material as fuel cladding in the FHR is shown in FIG. 10B. Because Inconel 718 is a ductile material, its maximum allowable stress is its yield strength [20]. The Inconel 718 profile exhibits both a large drop in yield strength and an intersection between effective stress and yield strength. These observations suggest that Inconel is not a suitable composite to expand the envelope of the FHR; the material experiences a prohibitive Von Mises stress profile before the operational limit of the original SiC cladding is met.

REX, an analytical reactor design tool, was developed to automatically identify and expand the operating envelopes of advanced solid-fuel nuclear reactor cores based on their fuel-clad, fuel-gas, and coolant-clad thermo-mechanics. With reactor geometry, coolant inlet temperature, and axially discretized detector and depletion results from Serpent as its inputs, REX performs full-core, pin-specific thermal-hydraulic and thermo-mechanical calculations to determine cladding mechanical stresses as functions of fuel depletion and coolant inlet temperature. It pushes the reactor operating envelope by increasing coolant inlet temperature until the coolant boiling point or cladding temperature limit is reached. It then modifies fuel pin geometries to induce mechanical failure of the original cladding material at the full extent of the fuel cycle and maximum permissible coolant inlet temperature. REX then replaces the original cladding with candidate alternative cladding materials specified by the user and evaluates their capability to expand the reactor operating envelope by testing their performance with the limiting fuel pin geometry.

REX is currently capable of analyzing reactor concepts outfitted with the fuels, coolants, and cladding materials listed in FIG. 8. The present disclosure contemplates additional modifications can be made to improve the accuracy and breadth the systems and methods disclosed herein. For example, systems and methods can be used with additional fuels, cladding materials, and coolants. The present disclosure also contemplates that cladding wall thinning can be incorporated as a function of coolant temperature and chemistry.

Additionally, non-limiting examples of additional reactor concepts that can be analyzed using the systems and methods disclosed herein include lead cooled flexible conversion ratio reactor [3] and the AFR-100 sodium-cooled fast reactor [21].

### Example 2

Another example implementation of the present disclosure is described herein. The example implementation includes modeling reactor neutronics in SERPENT including fuel pin fission rates, and assembly-average isotopic abundances and material densities. The example implementation also includes performing Coupled subchannel TH/TM calculations with simple 1.5-D model. The steps can include:
(1) Identify hottest fuel pin
(2) Force marginal yielding of clad material used in original core design (Fuel pin geometry manipulation)
(3) Test MMLC thermo-mechanics under original failure conditions (Varying width of corrosion-resistant layer)
(4) Push thermal power and temperature profiles for surviving CRL materials.

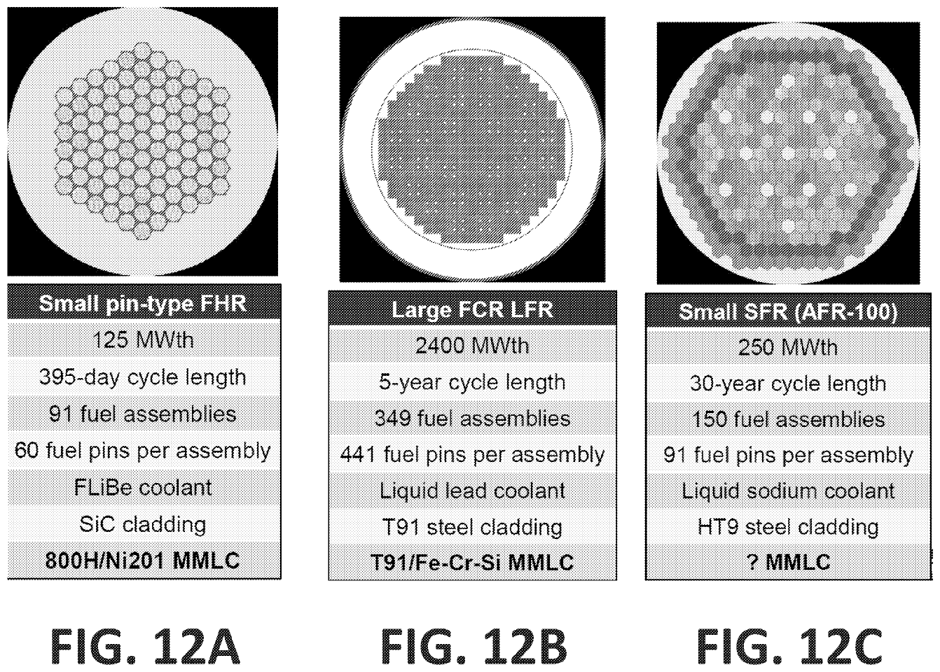

As shown in FIGS. 12A-12C, the example implementation can be used to design different reactor concepts. FIG. 12A illustrates example parameters for a fluoride salt-cooled high-temperature reactor (FHR). FIG. 12B illustrates example parameters for a lead cooled fast reactor. FIG. 12C illustrates example parameters for a sodium cooled reactor.

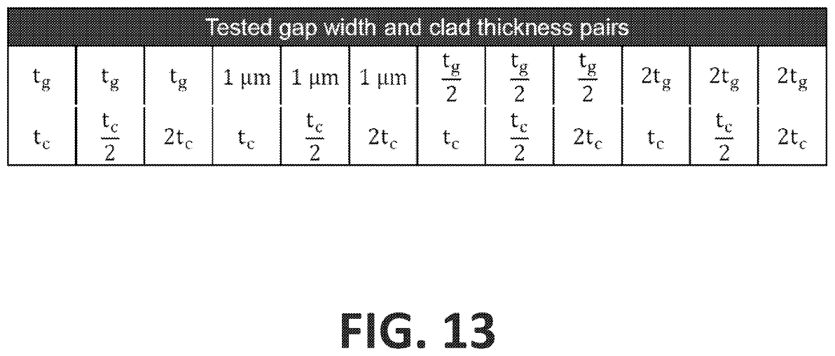

As shown in FIG. 13, the example implementation can include a geometry manipulation sequence that can test gap width and clad thickness pairs. The geometry manipulation sequence can include the steps of:
(1) Excess cladding stress can be retrieved for pre determined gap widths and clad thicknesses
(2) Test various gap widths within 20% of the width resulting in minimum, positive excess stress (t_{gmp}). Non-limiting examples of test-gap widths that can be tested include 0.8 t_{gmp}, 0.85 t_{gmp}, 0.9 t_{gmp}, 0.95 t_{gmp}, 1.05 t_{gmp}, 1.10 t_{gmp}, 1.15 t_{gmp}, and 1.20 t_{gmp}.
(3) Iterate on linear regression to determine gap width where 1 MPa>excess stress>0.
(4) Iterate on clad thickness instead after 100 iterations

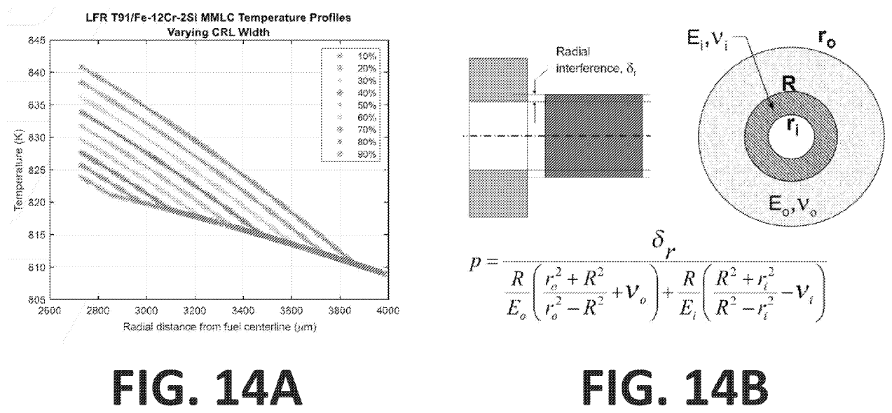

Additionally, checks can be performed to ensure that no tested geometry exceeds half the fuel pin pitch, and t_{g} can be set to 50 μm if as-designed width is 0. As shown in FIG. 14A temperature simulations can be performed for varying crl widths. The radial interference and interfacial pressures for press fits can also be analyzed using example implementations of the present disclosure, as shown in FIG. 14B. Non-limiting examples of designs that can be performed using the example implementation include U-Zr fuel thermo-mechanical parameters modeled for SFR analysis and for designs with Sodium coolant and HT9 cladding.

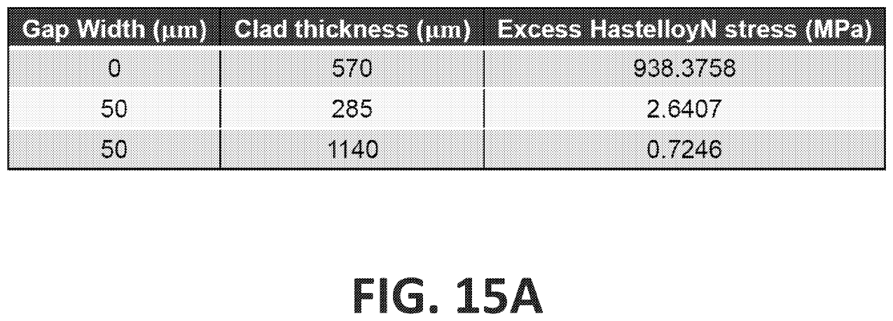

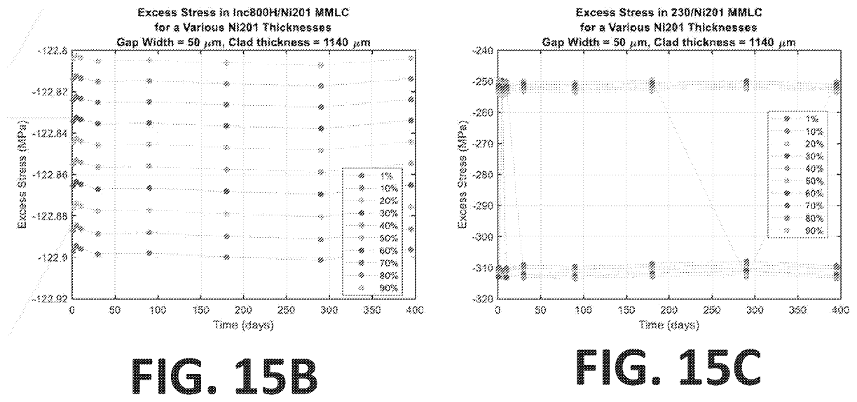

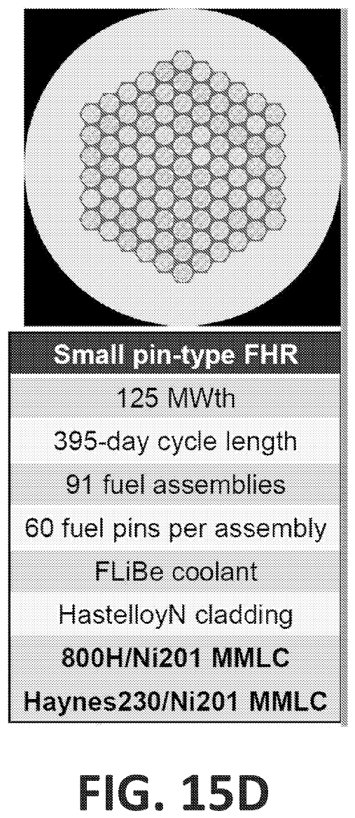

FIGS. 15A-15D illustrate example outputs from the example implementation of the present disclosure. Parameters of the reactor that were simulated are illustrated in FIG. 15D. The original SiC clad was replaced with HastelloyN due to corrosion data, and the predetermined geometries can be used to quickly yield useful results including determining an excess hastelloyN stress for different gap widths and clad thicknesses, illustrated in FIG. 15A. Base materials were tested with N201 CRL.

FIG. 15B illustrates the excess stress in Inc800H/Ni201 MMLC, and FIG. 15C illustrates excess stress in 230/Ni201 MMLC.

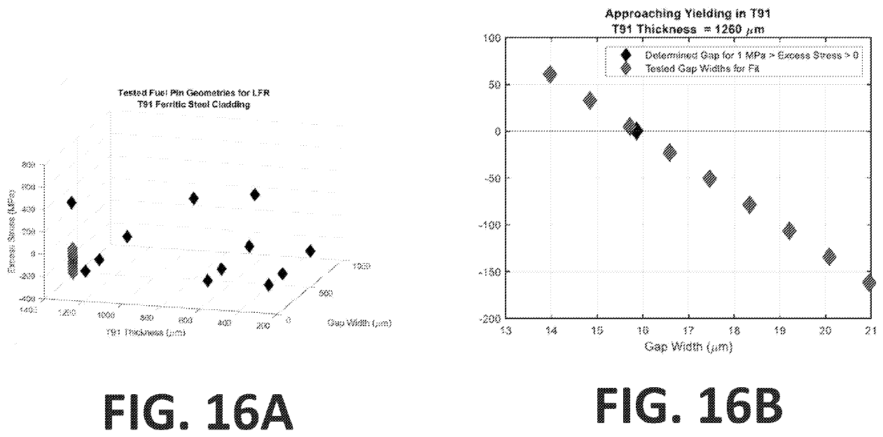

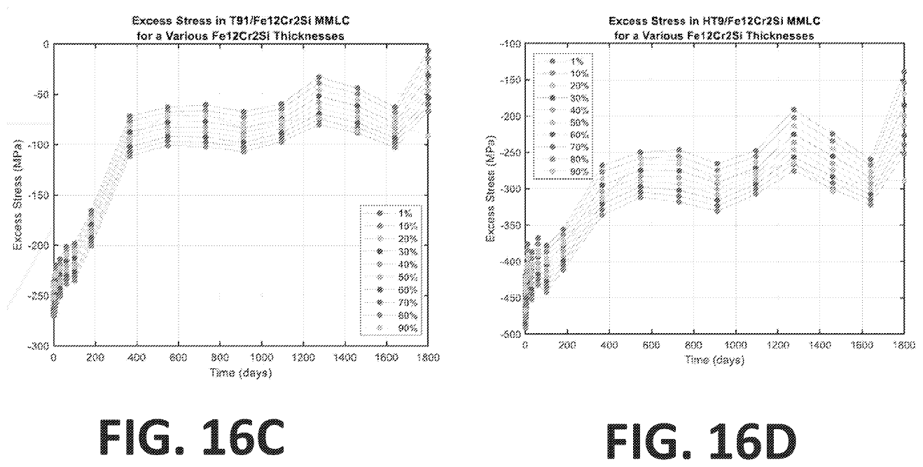

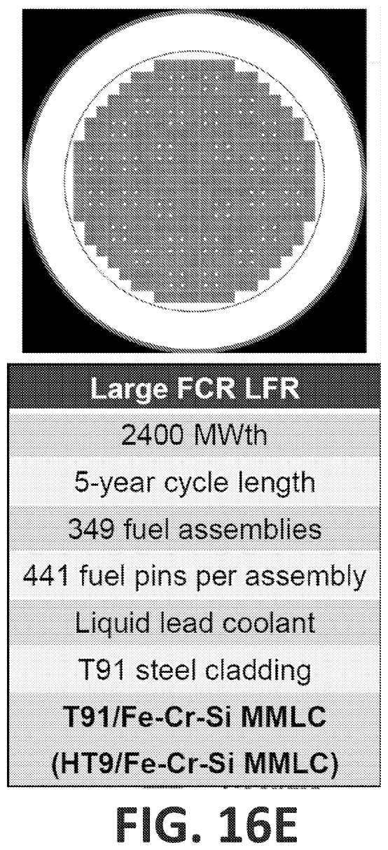

FIGS. 16A-16D illustrate additional experimental results for a Large FCR LFR reactor, with the parameters illustrated in FIG. 16E. FIG. 16A illustrates a plot of gap width, cladding thickness, and excess stress output by an example implementation of the present disclosure. FIG. 16B illustrates a plot of tests performed at different gap widths, according to an example implementation of the present disclosure. FIG. 16C illustrates a plot of excess stress over time for T91/Fe12Cr2Si, and FIG. 16D illustrates a plot of excess stress over time for HT9/Fe12Cr2Si, according to an example implementation of the present disclosure.

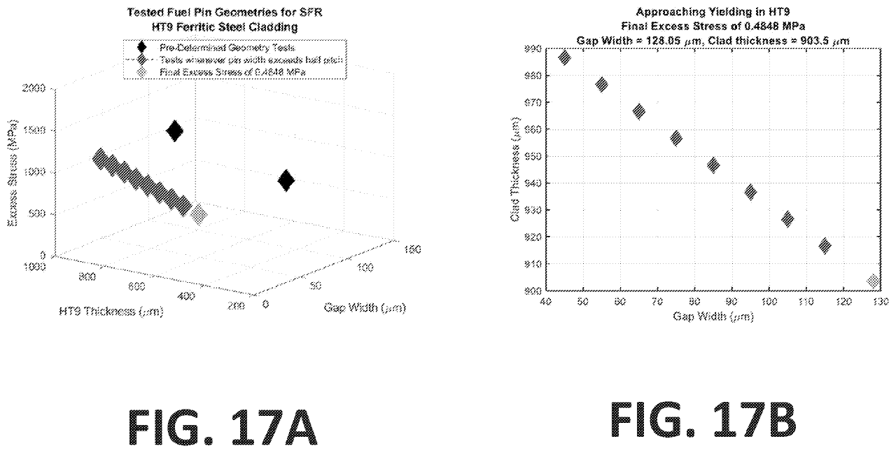

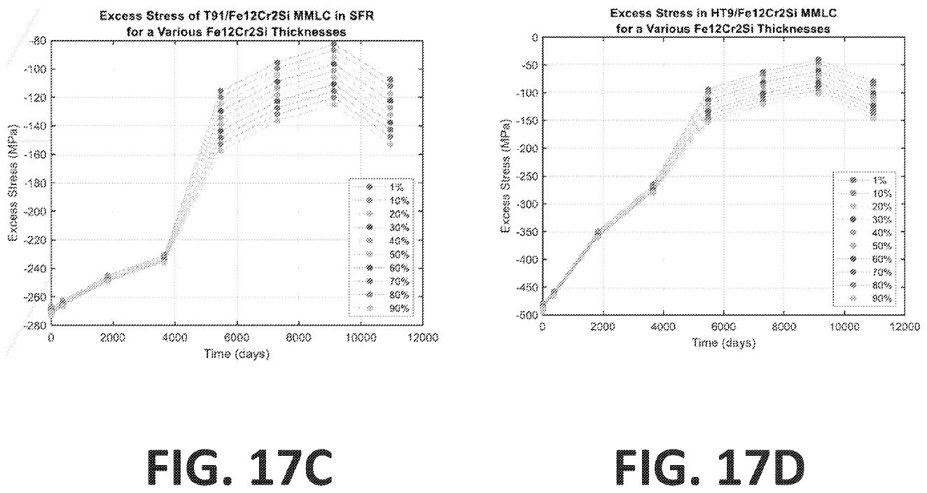

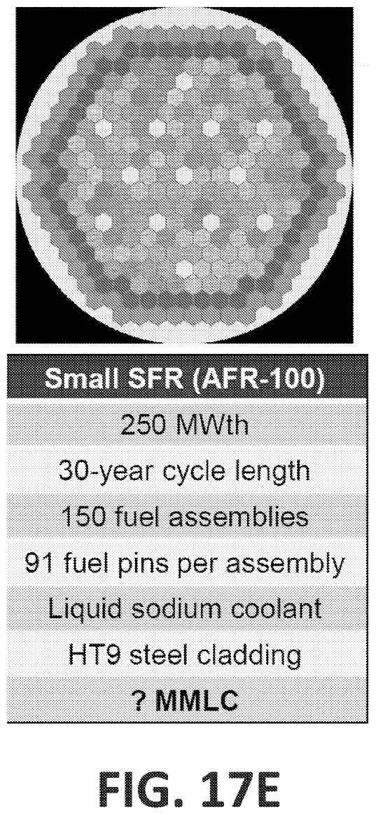

FIGS. 17A-17D illustrate additional experimental results for a small SFR reactor with the parameters illustrated in FIG. 17E. FIG. 17A illustrates a plot of gap width, HT9 thickness and excess stress output by an example implementation of the present disclosure. FIG. 17B illustrates a plot of clad thickness vs. gap width, according to an example implementation of the present disclosure. FIG. 17C illustrates a plot of excess stress of T91 over time, according to an example implementation of the present disclosure. FIG. 17D illustrates a plot of excess stress in HT9/Fe12Cr2Si, according to an example implementation of the present disclosure.

The results illustrated with reference to FIGS. 15A-17E show that implementations of the present disclosure can be used to create designs where extremely low stresses are present due to the fuel not contacting the clad, and/or as a result of the high thermal conductivity of the CRL.

Moreover, it should be understood that other implementations of the present disclosure can include higher-accuracy modeling of fuel-clad heat transfer during contact, where the modeling can include modeling as a function of cladding hardness or interfacial pressure. Additionally, implementations can be verified using comparisons to analytical models and core designs. Furthermore, implementations can increase the modeled temperature to force MMLC failure, and can relate higher temperatures to boosted thermal power predictions. Other implementations can include ana analysis of ARCH HX, and/or a model of FLiBe heated channel through an Inc800H/Ni201 tube.

### Example 3

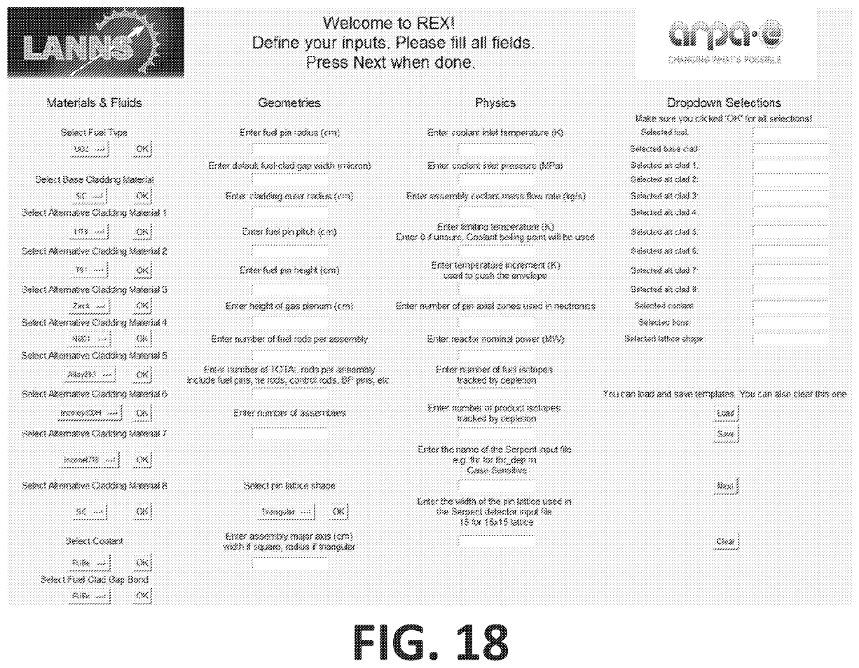

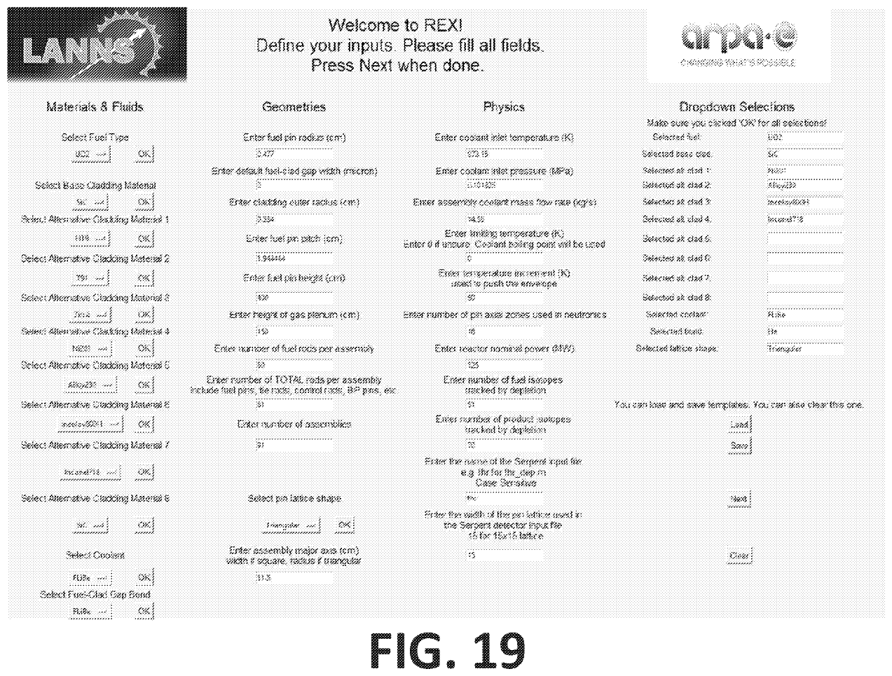

An example implementation of the present disclosure was created including a software program and graphical user interface. FIG. 18 shows an interface for inputting parameters. Additionally, the interface can be used to load a .rex file or save a .rex file that includes the inputs. FIG. 19, shows the example illustrated in FIG. 19 where the inputs have been filled in.

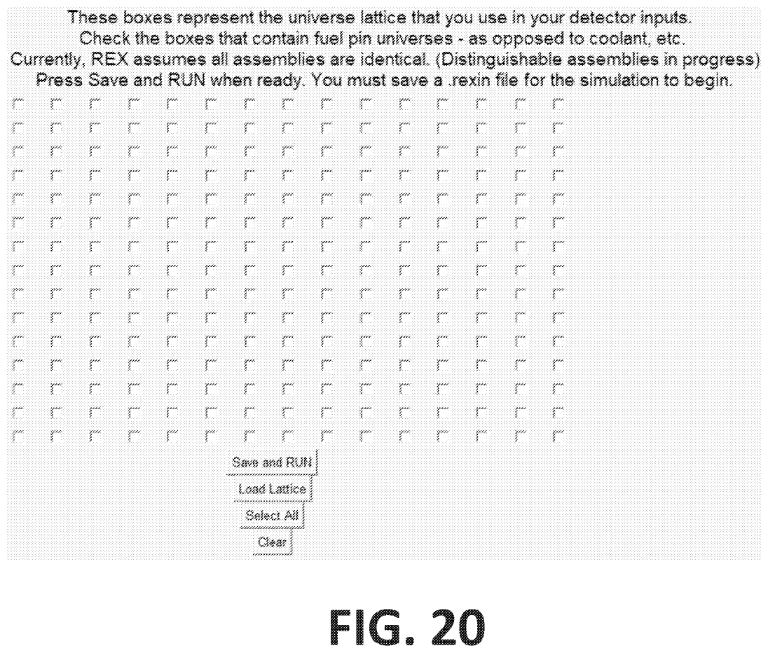

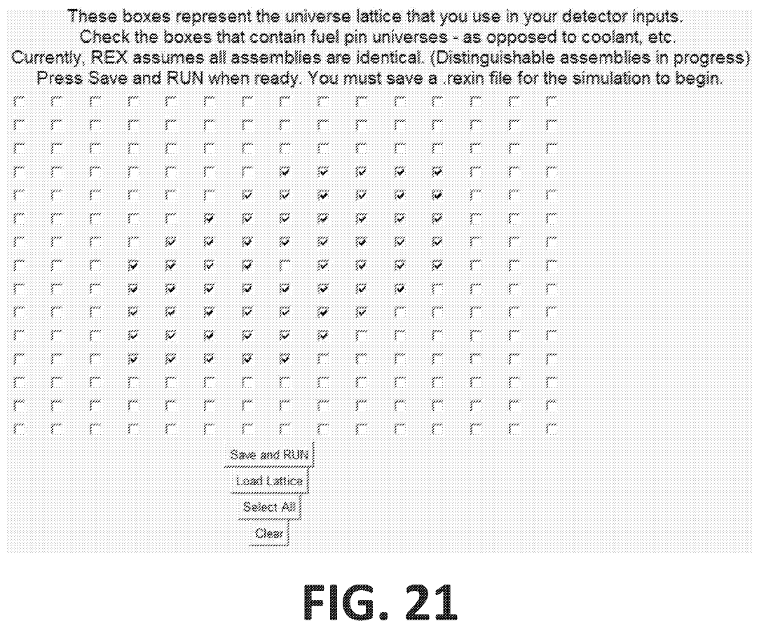

FIGS. 20 and 21 each illustrate an example user interface for inputting fuel pin positions in an assembly lattice. For example, the user can identify the fuel pin positions in the assembly lattice used in the neutronics problem in SERPENT 2. Pin positions can be saved and loaded from specialized .rexin files configured to store pin position information. The program can assume all assemblies are identical, or allow for the assemblies to be specified separately.

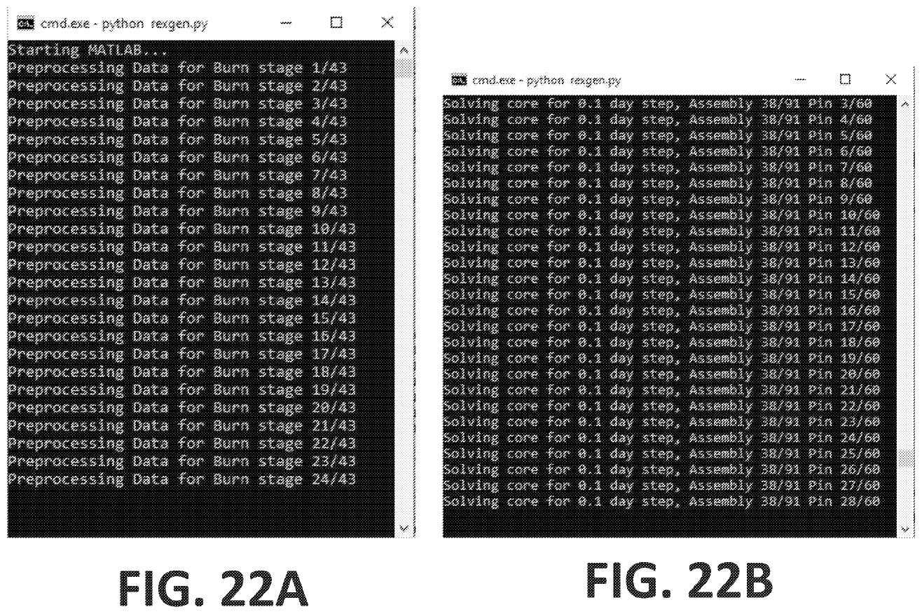

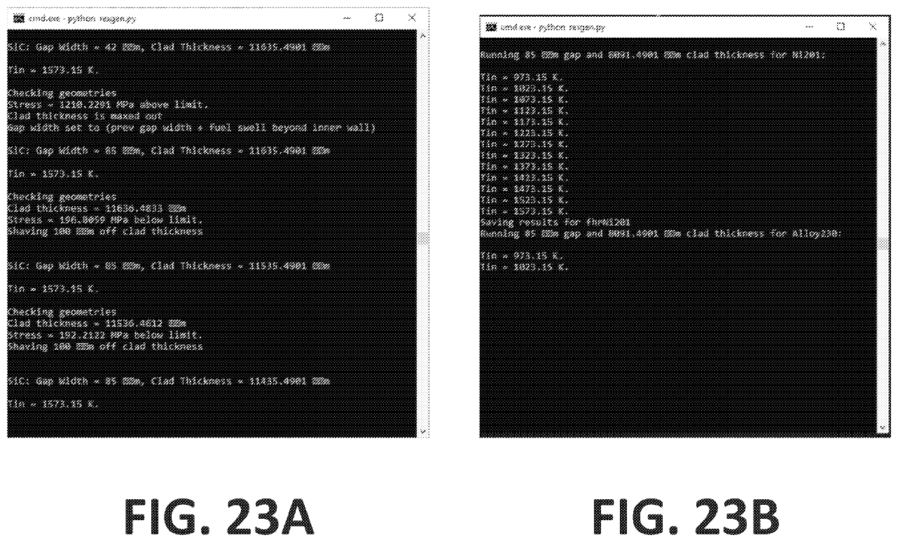

FIG. 22A illustrates an interface showing the data being processed from Serpent including processing data from depletion and detector results from Serpent. FIG. 22B illustrates an interface showing an example simulation quantifying thermal hydraulics and thermo-mechanics for the full core and identifying the fuel pin with the largest degree of radial deformation. FIG. 23A illustrates an interface showing a step of manipulating fuel pin geometry to force failure of base clad material (SiC) at the fullest extent of the operating envelope. FIG. 23B illustrates an interface showing testing the response of alternative materials with fuel pin geometry that limits the operation of the original material.

Results of manipulating fuel pin geometry with SiC and narrowly forcing a SiC fracture are illustrated with respect to FIGS. 9A-9B.

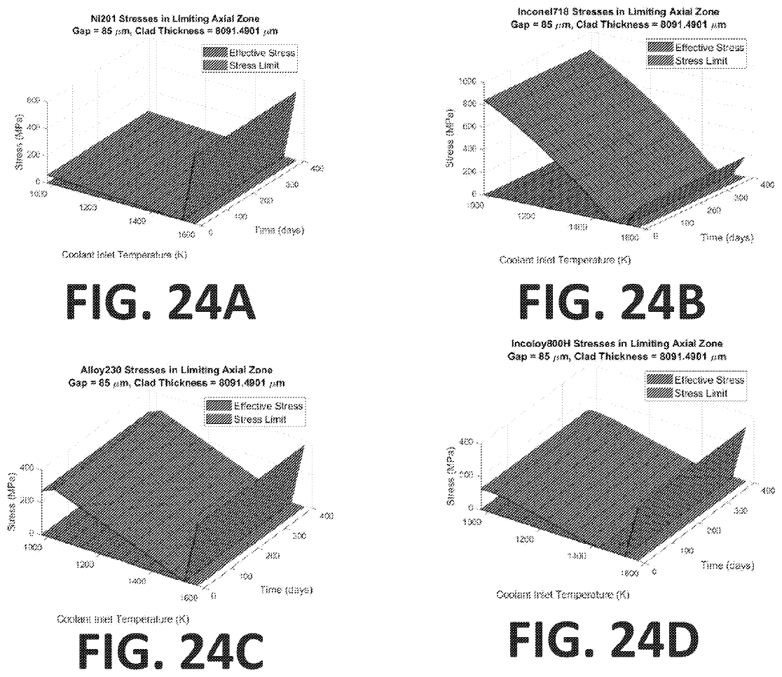

FIG. 10A illustrates SiC effective and maximum allowable stresses for the example implementation. FIGS. 24A-24D each illustrate the stresses in alternative materials. FIG. 24A illustrates the stresses in Ni201, FIG. 24B illustrates the stresses in Iconel718, FIG. 24C illustrates the stresses in Alloy 230 and FIG. 24D illustrates the stresses in Incoloy 800H.

It should be appreciated that the logical operations described herein with respect to the various figures may be implemented (1) as a sequence of computer implemented acts or program modules (i.e., software) running on a computing device (e.g., the computing device described in FIG. 11), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 11, an example computing device 1100 upon which the methods described herein may be implemented is illustrated. It should be understood that the example computing device 1100 is only one example of a suitable computing environment upon which the methods described herein may be implemented. Optionally, the computing device 1100 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1100 typically includes at least one processing unit 1106 and system memory 1104. Depending on the exact configuration and type of computing device, system memory 1104 may be volatile (such as random access memory (RAM)), non-volatile (such as read-only memory (ROM), flash memory, etc.), or some combination of the two. This most basic configuration is illustrated in FIG. 12 by dashed line 1102. The processing unit 1106 may be a standard programmable processor that performs arithmetic and logic operations necessary for operation of the computing device 1100. The computing device 1100 may also include a bus or other communication mechanism for communicating information among various components of the computing device 1100.

Computing device 1100 may have additional features/functionality. For example, computing device 1100 may include additional storage such as removable storage 1108 and non-removable storage 1110 including, but not limited to, magnetic or optical disks or tapes. Computing device 1100 may also contain network connection(s) 1116 that allow the device to communicate with other devices. Computing device 1100 may also have input device(s) 1114 such as a keyboard, mouse, touch screen, etc. Output device(s) 1112 such as a display, speakers, printer, etc. may also be included. The additional devices may be connected to the bus in order to facilitate communication of data among the components of the computing device 1100. All these devices are well known in the art and need not be discussed at length here.

The processing unit 1106 may be configured to execute program code encoded in tangible, computer-readable media. Tangible, computer-readable media refers to any media that is capable of providing data that causes the computing device 1100 (i.e., a machine) to operate in a particular fashion. Various computer-readable media may be utilized to provide instructions to the processing unit 1106 for execution. Example tangible, computer-readable media may include, but is not limited to, volatile media, non-volatile media, removable media and non-removable media implemented in any method or technology for storage of information such as computer readable instructions, data structures, program modules or other data. System memory 1104, removable storage 1108, and non-removable storage 1110 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1106 may execute program code stored in the system memory 1104. For example, the bus may carry data to the system memory 1104, from which the processing unit 1106 receives and executes instructions. The data received by the system memory 1104 may optionally be stored on the removable storage 1108 or the non-removable storage 1110 before or after execution by the processing unit 1106.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the reference list. For example, Ref. [1] refers to the 1^{st} reference in the list. All references cited and discussed in this specification are incorporated herein by reference in their entireties and to the same extent as if each reference was individually incorporated by reference.

Moreover, the various components may be in communication via wireless and/or hardwire or other desirable and available communication means, systems and hardware. Moreover, various components and modules may be substituted with other modules or components that provide similar functions.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

It should be appreciated that as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to human (e.g. rat, dog, pig, monkey), etc. It should be appreciated that the subject may be any applicable human patient, for example.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5).

Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.
[1] Aashique A. Rezwan, Michael R. Tonks, and Michael P. Short. Evaluations of the performance of multi-metallic layered composite cladding for the light water reactor accident tolerant fuel. Journal of Nuclear Materials, 535:152136, 2020.
[2] Michael Philip Short and Ronald George Ballinger. A functionally graded composite for service in high-temperature lead- and leadbismuth-cooled nuclear reactors-i: Design. Nuclear Technology, 177(3):366-381, 2012.
[3] Anna Nikiforova, Pavel Hejzlar, and Neil E. Todreas. Lead-cooled flexible conversion ratio fast reactor. Nuclear Engineering and Design, 239(12): 2596-2611, 2009. Flexible Conversion Fast Reactors Special Section with Regular Papers.
[4] Govindarajan Muralidharan, Dane F Wilson, Michael L Santella, and David Eugene Holcomb. Cladding alloys for fluoride salt compatibility final report. (ORNL/TM-201 1/95), 52011.
[5] EPRI. Fuel analysis and licensing code: FALCON MODO1: Volume 1: Theoretical and numerical bases. 2004.
state or reflect those of the United States Government or
[6] C. M. Allison, G. A. Berna, R. Chambers, E. W. Coryell, K. L. Davis, D. L. Hagrman, D. T. Hagrman, N. L. Hampton, J. K. Hohorst, R. E. Mason, M. L. McComas, K. A. McNeil, R. L. Miller, C. S. Olsen, G. A. Reymann, and L. J. Siefken. SCDAP/RELAP5/MOD3.1 code manual: MATPRO-a library of materials properties for light-water reactor accident analysis. 61995.
[7] Yong-Jun Deng, Jun Wei, Yang Wang, and Bin Zhang. Validation of the fuel rod performance analysis code fripac. Nuclear Engineering and Technology, 51(6): 1596-1609, 2019.
[8] Kenneth Geelhood, Walter Luscher, Patrick Raynaud, and Ian Porter. FRAPCON-4.0: A computer code for the calculation of steady-state, thermal-mechanical behavior of oxide fuel rods for high burnup. (PNNL-19418, Vol. 1 Rev. 2):1.1-1.2, 09 2015.
[9] J. D. Hales, R. L. Williamson, S. R. Novascone, G. Pastore, B. W. Spencer, D. S. Stafford, K. A. Gamble, D. M. Perez, and W. Liu. BISON theory manual the equations behind nuclear fuel analysis. (INL/EXT-13-29930): 4, 92016.
[10] Jaakko Leppänen, Maria Pusa, Tuomas Viitanen, Ville Valtavirta, and Toni Kaltiaisenaho. The serpent monte carlo code: Status, development and applications in 2013. Annals of Nuclear Energy, 82:142150, 2015. Joint International Conference on Supercomputing in Nuclear Applications and Monte Carlo 2013, SNA+MC 2013. Pluriand Trans-disciplinarity, Towards New Modeling and Numerical Simulation Paradigms.
[11] N. Kaffezakis and D. Kotlyar. Fuel cycle analysis of novel assembly design for thorium-uranium-ceramic-fueled thermal, highconversion reactor. Nuclear Technology, 206(1):48-72, 2020
[12] Neil E. Todreas and Mujid S. Kazimi. Nuclear Systems I: Thermal Hydraulic Fundamentals, pages 332-334. Taylor & Francis, 1989.
[13] Neil E. Todreas and Mujid S. Kazimi. Nuclear Systems I: Thermal Hydraulic Fundamentals, page 581. Taylor & Francis, 1989.
[14] Neil E. Todreas and Mujid S. Kazimi. Nuclear Systems I: Thermal Hydraulic Fundamentals, page 379. Taylor & Francis, 1989
[15] Neil E. Todreas and Mujid S. Kazimi. Nuclear Systems I: Thermal Hydraulic Fundamentals, pages 305-306. Taylor & Francis, 1989.
[16] Bo-Shiuan Li. Pellet cladding mechanical interactions of ceramic claddings fuels under light water reactor conditions. Master's thesis, University of South Carolina, 2013.
[17] Kenneth Geelhood, Walter Luscher, Patrick Raynaud, and Ian Porter. FRAPCON-4.0: A computer code for the calculation of steady-state, thermal-mechanical behavior of oxide fuel rods for high burnup. (PNNL-19418): 2.32-2.33, 092015
[18] Hassan Mohamed, Dan Kotlyar, Geoffrey Parks, and Yaniv Shaposhnik. Coupled neutronic-thermal-hydraulic analysis of a small FHR core with pin-type fuel assemblies. PHYSOR 2014: 1-5, 2014
[19] Nasr M. Ghoniem. High-temperature mechanical and material design for SiC composites. Journal of Nuclear Materials, 191-194:515-519, 1992. Fusion Reactor Materials Part A.
[20] Special Metals. Inconel alloy 718. pages 1-2, 10. https://www. specialmetals.com/documents/Inconelalloy718. pdf Accessed 1 Apr. 2021
[21] Christopher Grandy, James J. Sienicki, Anton Moisseytsev, Lubomir Krajtl, Mitchell T. Farmer, Taek K. Kim, and B. Middleton. Advanced fast reactor—100(AFR-100) report for the technical review panel ANL-ARC-288, 62014 any agency thereof.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method for analyzing an operating envelope of a nuclear reactor comprising:
a) receiving a plurality of reactor input parameters for a reactor core comprising a first fuel-cladding material, the reactor input parameters comprising geometric parameters, coolant parameters, fuel parameters, and neutronic parameters;
b) for each of a plurality of depletion steps in a fuel cycle, performing a plurality of thermo-hydraulic and thermo-mechanical calculations for the reactor core comprising the first fuel-cladding material based on the reactor input parameters;
c) repeating step (b) for each of a plurality of coolant inlet temperatures to obtain a plurality of operating envelope parameters associated with the reactor core comprising the first fuel-cladding material;
d) modifying a fuel pin geometry of the reactor core comprising the first fuel-cladding material;
e) for each of the plurality of depletion steps in the fuel cycle, performing the plurality of thermo-hydraulic and thermo-mechanical calculations for the reactor core comprising the first fuel-cladding material based on the reactor input parameters and the modified fuel pin geometry;
f) repeating step (e) for each of the plurality of coolant inlet temperatures to obtain a plurality of operating envelope parameters associated with the reactor core comprising the first fuel-cladding material and having the modified fuel pin geometry;
g) for each of the plurality of depletion steps in the fuel cycle, performing the plurality of thermo-hydraulic and thermo-mechanical calculations for the reactor core comprising a second fuel-cladding material based on the reactor input parameters, the modified fuel pin geometry, and a change in fuel-cladding material;
h) repeating step (g) for each of the plurality of coolant inlet temperatures to obtain a plurality of reactor operating envelope parameters associated with the reactor core comprising the second fuel-cladding material and having the modified fuel pin geometry; and
i) determining whether a reactor operating envelope of the reactor core is expanded as a result of the change in fuel-cladding material by comparing the respective operating envelope parameters associated with the reactor core comprising the first fuel-cladding material and the reactor core comprising the second fuel-cladding material and having the modified fuel pin geometry.

2. The method of claim 1, wherein the plurality of thermo-hydraulic and thermo-mechanical calculations comprises pin-specific calculations of one or more of coolant, cladding, and fuel temperature profiles; fuel deformations; cladding deformations; or pressures at the coolant-cladding, fuel-cladding, and gas-clad interfaces.

3. The method of claim 1, wherein the fuel pin geometry comprises one or more of a fuel-cladding gap width or a cladding thickness.

4. The method of claim 1, wherein each of steps (b), (e), and (g) are repeated until the fuel cycle is complete.

5. The method of claim 1, wherein each of steps (c), (f), and (h) are repeated at incrementally increasing coolant inlet temperatures.

6. The method of claim 1, wherein steps (e)-(f) are repeated until an effective stress on the first fuel-cladding material is greater than a maximum allowable stress on the first fuel-cladding material at a final depletion step of the fuel cycle and a final coolant inlet temperature.

7. The method of claim 1, wherein the operating envelope parameters are indexed to an assembly, a fuel pin, an axial zone, a depletion step, and a coolant inlet temperature.

8. The method of claim 1, wherein the operating envelope parameters comprise one or more of temperature parameters, pressure parameters, fuel deformation parameters, cladding deformation parameters, or mechanics parameters.

9. The method of claim 8, wherein the temperature parameters comprise one or more of a coolant outlet temperature, a coolant bulk temperature, a cladding inner surface temperature, a cladding outer surface temperature, a fuel surface temperature, a fuel centerline temperature, or a fuel average temperature.

10. The method of claim 8, wherein the pressure parameters comprise one or more of a fuel-cladding interface pressure, a fuel-gas interface pressure, or a coolant-cladding interface pressure.

11. The method of claim 8, wherein the fuel deformation parameters comprise one or more of a thermal expansion, a relocation densification, a swelling due to fission products, an elasticity, or a creep.

12. The method of claim 8, wherein the cladding deformation parameters comprise a thermal expansion.

13. The method of claim 8, wherein the mechanics parameters comprise one or more of a maximum allowable cladding stress or an effective cladding stress.

14. The method of claim 1, wherein the geometric parameters comprise one or more of a fuel radius, a cladding thickness, an active core height, a plenum height, a pin pitch, an assembly coolant channel radius or apothem, a number of assemblies, or a number of fuel pins per assembly.

15. The method of claim 1, wherein the coolant parameters comprise one or more of a mass flow rate, a coolant inlet temperature, a coolant boiling point, or a coolant inlet pressure.

16. The method of claim 1, wherein the fuel parameters comprise one or more of a theoretical fuel density or a fuel cycle length.

17. The method of claim 1, wherein the neutronic parameters comprise one or more of an axially discretized pin fission rate, a core nominal power, a fuel and fission product isotropic inventory as a functions of depletion, or a number of depletion steps.

18. A system for analyzing an operating envelope of a nuclear reactor comprising:
a processor; and
a memory operably coupled to the processor, the memory having computer-executable instructions stored thereon that, when executed by the processor, cause the processor to:
a) receive a plurality of reactor input parameters for a reactor core comprising a first fuel-cladding material, the reactor input parameters comprising geometric parameters, coolant parameters, fuel parameters, and neutronic parameters;
b) for each of a plurality of depletion steps in a fuel cycle, perform a plurality of thermo-hydraulic and thermo-mechanical calculations for the reactor core comprising the first fuel-cladding material based on the reactor input parameters;
c) repeat step (b) for each of a plurality of coolant inlet temperatures to obtain a plurality of operating envelope parameters associated with the reactor core comprising the first fuel-cladding material;
d) modify a fuel pin geometry of the reactor core comprising the first fuel-cladding material;
e) for each of the plurality of depletion steps in the fuel cycle, perform the plurality of thermo-hydraulic and thermo-mechanical calculations for the reactor core comprising the first fuel-cladding material based on the reactor input parameters and the modified fuel pin geometry;
f) repeat step (e) for each of the plurality of coolant inlet temperatures to obtain a plurality of operating envelope parameters associated with the reactor core comprising the first fuel-cladding material and having the modified fuel pin geometry;
g) for each of the plurality of depletion steps in the fuel cycle, perform the plurality of thermo-hydraulic and thermo-mechanical calculations for the reactor core comprising a second fuel-cladding material based on the reactor input parameters, the modified fuel pin geometry, and a change in fuel-cladding material;
h) repeat step (g) for each of the plurality of coolant inlet temperatures to obtain a plurality of reactor operating envelope parameters associated with the reactor core comprising the second fuel-cladding material and having the modified fuel pin geometry; and
i) determine whether a reactor operating envelope of the reactor core is expanded as a result of the change in fuel-cladding material by comparing the respective operating envelope parameters associated with the reactor core comprising the first fuel-cladding material and the reactor core comprising the second fuel-cladding material and having the modified fuel pin geometry.

19-34. (canceled)

35. A computer implemented method for analyzing an operating envelope of a nuclear reactor comprising:
obtaining a plurality of operating envelope parameters associated with a first reactor core by performing a plurality of thermo-hydraulic and thermo-mechanical calculations for the first reactor core, wherein the first reactor core comprises a first fuel-cladding material and has a first fuel pin geometry;
obtaining a plurality of operating envelope parameters associated with a second reactor core by performing a plurality of thermo-hydraulic and thermo-mechanical calculations for the second reactor core, wherein the second reactor core comprises a second fuel-cladding material and has a second fuel pin geometry; and
assessing an expandable operating envelope by comparing the respective operating envelope parameters associated with the first reactor core and the second reactor core, wherein the first and second fuel-cladding materials are different materials.

36-38. (canceled)

39. The method of claim 35, wherein the plurality of thermo-hydraulic and thermo-mechanical calculations are iteratively performed for each of a plurality of depletion steps in a fuel cycle.

40-46. (canceled)
